(19) United States
(12) Patent Application Publication
(10) Pub. No.: US 2025/0374389 A1
(43) Pub. Date: Dec. 4, 2025

(54) COOKING APPLIANCE WITH DIGITAL CONTROLLER DOOR AND METHOD FOR CONTROLLING POWER-OFF OF COOKING APPLIANCE

(71) Applicant: LG Electronics Inc., Seoul (KR)

(72) Inventors: Dong Hun KIM, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/222,332

(22) Filed: May 29, 2025

(30) Foreign Application Priority Data
May 30, 2024 (KR) 10-2024-0070766
Dec. 16, 2024 (KR) 10-2024-0187289
Mar. 13, 2025 (KR) 10-2025-0032653

(51) Int. Cl. H05B 6/64; G09G 3/3208; G09G 3/36

(52) U.S. Cl. CPC H05B 6/6435; G09G 3/36; G09G 3/3208; G09G 2320/0613; G09G 2330/027; G09G 2354/00

(57) ABSTRACT

A cooking appliance can include a main portion including a cavity for receiving food, and one or more functional components, the main portion being configured to provide a cooking function, a display door coupled to the main portion, the display door including a display configured to provide a user interface, and a door controller control the display door. Also, the door controller is configured to in response to executing a hard power-off mode, power off the door controller, and in response to executing a soft power-off mode, power off the display of the display door while the door controller remains in an active state.

### CROSS-REFERENCE TO RELATED APPLICATION

This application claims priority to and the benefit of Korean Patent Application No. 10-2024-0070766, filed on May 30, 2024, Korean Patent Application No. 10-2024-0187289, filed on Dec. 16, 2024, and Korean Patent Application No. 10-2025-0032653, filed on Mar. 13, 2025, in the Republic of Korea, the entireties of all of these applications are incorporated herein by reference.

### BACKGROUND

### Field

The present disclosure relates to a cooking appliance including a digital controller door and a method for controlling power-off of the cooking appliance.

### Description of Related Art

A cooking appliance is a home appliance that cooks food using microwaves belonging to electromagnetic waves and/or heater heat. The cooking appliance can be generally provided with a cavity as a space in which food is placed and cooked, and a door for opening and closing the cavity.

When the cooking appliance is installed indoors, it is desirable to consider efficient use of the cooking appliance, saving of an installation space thereof, etc.

For this reason, the cooking appliance can be disposed at a position adjacent to a heating cooking device, for example, a heating oven, a gas stove, etc. Specifically, the cooking appliance can be disposed on top of the heating cooking device.

When the cooking appliance is disposed on top of the heating cooking device, the user can conveniently cook food by reducing the movement of the user in an environment in which the cooking appliance and the heating cooking device are adjacent to each other. In addition, heat, oil vapor, etc. as generated from the heating cooking device can be discharged to the outside using the cooking appliance as a hood.

In a state in which the cooking appliance is disposed on top of the heating cooking device, heat, oil vapor, or the like generated from the heating cooking device disposed under the cooking appliance can adversely affect the operation of the cooking appliance.

For example, a display can be mounted on a front surface of a door provided in the cooking appliance and can be configured to provide various information to the user. The user can know a cooking state of the cooked food through the display.

In addition, when the display is connected to another home appliance to serve as a hub of the home appliances, information other than cooking food can be obtained through the display. In addition, the user can input a command necessary for cooking and various other commands to the display in a touch manner.

In a state in which the cooking appliance is disposed on top of the heating cooking device, heat, oil vapor, etc. generated from the heating cooking device can invade into parts mounted on the display and the door.

It is desirable to suppress damage to or malfunction of the display of the cooking appliance and other components mounted on the door due to such heat, oil vapor, or the like.

The heat generated from the heating cooking device can rise under a convection to heat the display mounted on the cooking appliance, thereby causing the display to be damaged by the heat or causing a malfunction of the display.

Therefore, proper cooling is required so that the display does not become overheated. At least one fan device can be used to cool the display. However, when a large number of fan devices are used to cool the display or the fan device is rotated at an excessively high speed, noise of the fan device can make the user uncomfortable and excessive electricity can be consumed by the fan device.

A component for controlling the display and a component for controlling the operation of the cooking appliance operate in different operating manners. The component that controls the display can act as an information processing unit in that it interacts with the user. On the other hand, the cooking appliance can repeatedly perform a specific function.

Accordingly, a need exists for a scheme of defining a control of these two components or information flow manner therebetween and setting a process corresponding thereto so that the cooking appliance can be safely controlled in a normal operation and an abnormal operation situation. In particular, it is necessary to control the cooking appliance so that the cooking appliance can be turned off safely.

### SUMMARY OF THE DISCLOSURE

Thus, the present disclosure has been devised to solve the above problem. A purpose of the present disclosure is to provide a cooking appliance including a digital controller door and a method for controlling power-off of the cooking appliance in which various software or hardware of a door coupled to the cooking appliance cooperates smoothly with a control component for controlling the cooking appliance, and the cooking appliance can be safely controlled by turning off the power to some components of the cooking appliance.

Further, a purpose of the present disclosure is to provide a cooking appliance including a digital controller door and a method for controlling power-off of the cooking appliance in which the power applied to components can be safely turned off according to various power-off schemes and based on a current status of the cooking appliance in a process of power-off the digital control door coupled to the cooking appliance.

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be easily understood that the purposes and advantages according to the present disclosure can be realized using means shown in the claims or combinations thereof.

A cooking appliance including a digital controller door according to an embodiment of the present disclosure includes a functional unit e.g., main body or main portion of the cooking appliance) configured to provide a cooking function; and the digital controller door configured to provide a human interface, in which digital controller door includes an operating system (OS) controller for controlling the digital controller door, in which the operating system (OS) controller is configured to perform a hard power-off mode or a soft power-off mode, in which in the hard power-off mode, the operating system (OS) controller is configured to power-off the OS controller, in which in the soft power-off mode, the OS controller is configured to power-off a display of the digital controller door.

A method for controlling power-off of a cooking appliance including a digital controller door according to an embodiment of the present disclosure is provided. The cooking appliance includes: a functional unit configured to provide a cooking function; and the digital controller door configured to provide a human interface, in which digital controller door includes an operating system (OS) controller for controlling the digital controller door. The method can include starting, by the OS controller, a hard power-off mode or a soft power-off mode; and power-off, by the OS controller, a component of the digital controller door, based on whether a power-off mode is the hard power-off mode or the soft power-off mode, in which in the hard power-off mode, the power of the OS controller is turned off, in which in the soft power-off mode, the OS controller powers-off a display of the digital controller door.

A cooking appliance according to an embodiment of the present disclosure is provided. The cooking appliance includes a main portion including a cavity for receiving food, and one or more functional components. The main portion is configured to provide a cooking function. The cooking appliance includes a display door coupled to the main portion, and the display door includes a display configured to provide a user interface. The cooking appliance includes a door controller configured to in response to determining that at least one predetermined condition related to the display door is present or satisfied. And the door controller transmits at least one request message to a main controller of the main portion and executes a hard power-off mode to power off the door controller.

The predetermined condition includes at least one of a temperature condition of the display door being greater than a predetermined value, a user input instructing the hard power-off mode to be executed, or a communication error between the door controller and a main controller of the main portion.

The request message includes at least one of a cooking cancelation request to stop a cooking operation of the main portion, a turn off request to turn off at least one of the one or more functional components, or a request for a feedback response for informing the door controller of a status of one of the one or more functional components or a status of the cooking operation.

The door controller is configured to wait for a predetermined amount of time for receiving a response to at least one request message from a main controller of the main portion before turning off the door controller.

The door controller can execute the hard power-off mode to power off the door controller in response to a communication error occurring between the door controller and a main controller of the main portion.

The door controller can execute the hard power-off mode to power off the door controller in response to a temperature sensed by a sensor of the display door exceeding a predetermined condition while the main portion is not currently cooking food.

When a remaining cook time of food currently being cooked by the main portion being less than a predetermined wait available time, the door controller can wait until the remaining cook time has elapsed and then transmit a signal to the main controller to turn off at least one of the one or more functional components in the main portion.

In accordance with the present disclosure, the various software or hardware of the door coupled to the cooking appliance cooperates smoothly with the control component for controlling the cooking appliance. Further, the cooking appliance can be safely controlled by turning off the power to some components of the cooking appliance.

In accordance with the present disclosure, the power applied to components can be safely turned off according to various power-off schemes and based on a current status of the cooking appliance in a process of power-off the digital control door coupled to the cooking appliance.

The effects of the present disclosure are not limited to the above-described effects, and those skilled in the art can derive various effects of the present disclosure from the configuration of the present disclosure.

### BRIEF DESCRIPTION OF DRAWINGS

The above and other objects, features, and advantages of the present disclosure will become more apparent to those of ordinary skill in the art by describing example embodiments thereof in detail with reference to the attached drawings, which are briefly described below.

FIG. 1 is a conceptual diagram of a cooking appliance including a digital controller door according to an embodiment of the present disclosure.

FIG. 2 is a diagram illustrating components of a digital controller door and components of a functional unit according to an embodiment of the present disclosure.

FIG. 3 is a diagram illustrating categories of functions performed by an OS controller and a function controller according to an embodiment of the present disclosure.

FIG. 4 is a perspective view illustrating a cooking appliance according to an embodiment of the present disclosure.

FIG. 5 is a diagram illustrating a state in which the digital controller door (e.g., display door or smart door) is opened in FIG. 4 according to an embodiment of the present disclosure.

FIG. 6 is a perspective view illustrating a digital controller door of a cooking appliance according to an embodiment of the present disclosure.

FIG. 7 is a schematic view illustrating a position where a cooking appliance is disposed according to an embodiment of the present disclosure.

FIG. 8 is a diagram showing a process of hard power-off a digital controller door according to an embodiment of the present disclosure.

FIG. 9 is a diagram showing a process of soft power-off a digital controller door according to an embodiment of the present disclosure.

FIG. 10 is a diagram showing a process of soft power-off a digital controller door according to another embodiment of the present disclosure.

FIG. 11 is a diagram showing a process in which an OS controller operates or controls other components in a hard power-off process according to an embodiment of the present disclosure.

FIG. 12 is a diagram showing a process in which an OS controller operates or controls other components in a soft power-off process according to an embodiment of the present disclosure.

FIG. 13 is a diagram showing a process of selectively performing cooking cancellation in a power-off process according to an embodiment of the present disclosure.

FIG. 14 is a diagram showing a process of outputting information related to performing a power-off according to an embodiment of the present disclosure.

FIG. 15 is a diagram showing a process of increasing or decreasing a wait available time according to an embodiment of the present disclosure.

FIG. 16 is a diagram showing a power-off process according to an embodiment of the present disclosure.

FIG. 17 is a diagram showing an area of a display according to an embodiment of the present disclosure.

FIG. 18 is a diagram showing a process of turning off only a partial area of a display when an OS controller is configured to perform a soft power-off mode according to one embodiment of the present disclosure.

FIG. 19 is a diagram showing an example in which only a partial area of a display is in a soft power-off while the other area thereof displays information according to one embodiment of the present disclosure.

FIG. 20 is a diagram showing an example in which information is displayed in a specific area of a display in a soft power-off state according to one embodiment of the present disclosure.

### DETAILED DESCRIPTION OF THE EMBODIMENTS

Hereinafter, embodiments of the present disclosure will be described in detail with reference to the drawings so that those skilled in the art to which the present disclosure pertains can easily implement the present disclosure. The present disclosure can be implemented in several different forms and is not limited to the embodiments described herein.

In order to clearly describe the present disclosure, parts irrelevant to the description are omitted, and the same reference numerals refer to the same or similar components throughout the specification. Further, some embodiments of the present disclosure will be described in detail with reference to the example drawings. In adding reference numerals to the components of each drawing, the same components can be denoted by the same reference numerals as much as possible even though the components are shown in different drawings. In addition, in describing the present disclosure, when it is determined that a detailed description of related known components or functions can obscure the gist of the present disclosure, the detailed description thereof can be omitted.

It will be understood that, although the terms “first,” “second,” “third,” and so on can be used herein to describe various elements, components, areas, layers and/or units, these elements, components, areas, layers and/or units should not be limited by these terms. These terms are used to distinguish one element, component, area, layer or unit from another element, component, area, layer or unit. Thus, a first element, component, area, layer or unit as described under could be termed a second element, component, area, layer or unit, without departing from the spirit and scope of the present disclosure. It will be understood that when a first element or layer is referred to as being “connected to,” “jointed to” or “coupled to” a second element or layer, the first element can be directly connected to or jointed to or coupled to the second element or layer, or one or more intervening elements or layers can be present therebetween. In addition, it will also be understood that when an element or layer is referred to as being “between” two elements or layers, it can be the only element or layer between the two elements or layers, or one or more intervening elements or layers can also be present therebetween.

In addition, in the implementation of the present disclosure, the component can be subdivided for convenience of description. However, this component can be implemented in one device or module, or one component can be implemented to be distributed into a plurality of devices or modules.

The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

The present disclosure relates to a technique for controlling a cooking appliance using a digital controller door disposed at a front surface of the cooking appliance.

According to the present disclosure, a door of a microwave oven disposed on an oven or a gas stove includes an LCD or OLED screen. An Android of the LCD or OLED screen and a microcomputer of the microwave oven cooperate with each other. An LCD or OLED component operates according to various operating/external environments of the microwave oven or controls a specific function of the microwave oven.

The digital controller door of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD or OLED screen providing various user interfaces such as a touch screen, and is capable of storing and cooking food therein. And embodiments of the present disclosure is not limited to a specific display panel type.

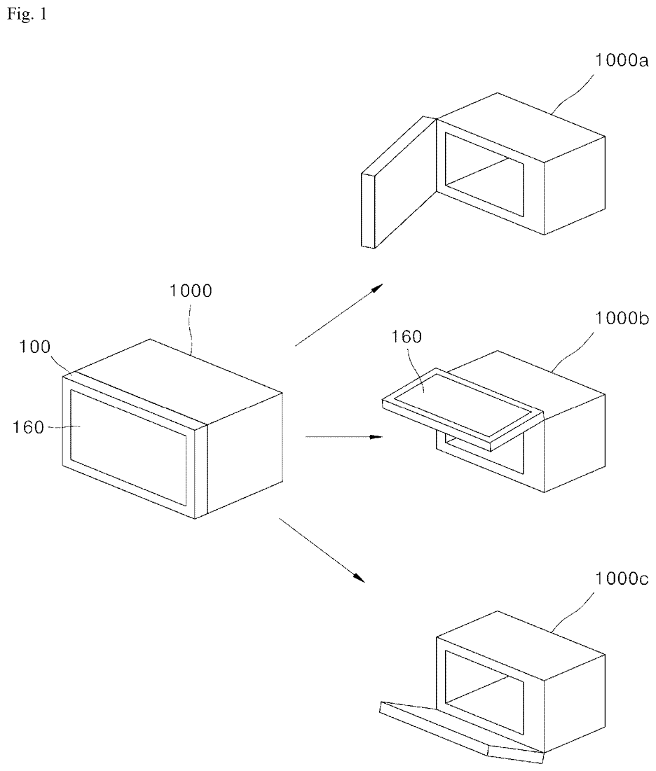

FIG. 1 is a conceptual diagram of a cooking appliance including a digital controller door according to an embodiment of the present disclosure.

The cooking appliance 1000 includes a digital controller door 100 at a front surface thereof. The digital controller door 100 includes one or two or more displays, and the display of the digital controller door 100 can display information about the inside of the cooking appliance 1000 or information related to an operation thereof to the user. The display of the digital controller door 100 can provide a touch input interface for receiving a predetermined command from the user.

A manner in which the digital controller door 100 is opened includes an embodiment 1000a, 1000b, or 1000c. 1000a shows an embodiment in which the digital controller door 100 pivots around a left side of the cooking appliance 1000a to open the right side of the cooking appliance 1000a, and open the inside of the cooking appliance 1000a. 1000b shows an embodiment in which the digital controller door 100 pivots around a top side of the cooking appliance 1000b to open the bottom side of the cooking appliance 1000b, and open the inside of the cooking appliance 1000b. 1000c shows an embodiment in which the digital controller door 100 pivots around a bottom side of the cooking appliance 1000c to open the top side of the cooking appliance 1000c, and open the inside of the cooking appliance 1000c.

A display 160 can be mounted on the front surface of the digital controller door 100 to provide various information to a user. The user can know the cooking state of the cooked food on the display 160. The display 160 can be embodied as an LCD. However, embodiments of the present disclosure is not limited thereto, and the display 160 can include various display panels. In addition, a touch panel for touch input can be coupled to the display 160.

The digital controller door 100 controls the operation of the cooking appliance 1000 and outputs various information. The cooking appliance 1000 performs cooking using microwaves or heater heat. Accordingly, a digital controlling function provided by the digital controller door 100 and a cooking function of the cooking appliance 1000 are provided in different ways and in different areas.

The digital controller door 100 of the present disclosure can serve as a kind of a hub. That is, the digital controller door 100 can serve as a hub of another home appliance and display information transmitted from another home appliance on the display 160. In this process, the user can obtain other information other than the cooking food on the display 160. In addition, the user can input a command necessary for cooking and various other commands to the display 160 in a touch manner.

To this end, in accordance with the present disclosure, a method and a configuration in which the digital controller door 100 and the cooking appliance 1000 respectively include independent control components, and these control components cooperate with each other to control the function of the cooking appliance will be described.

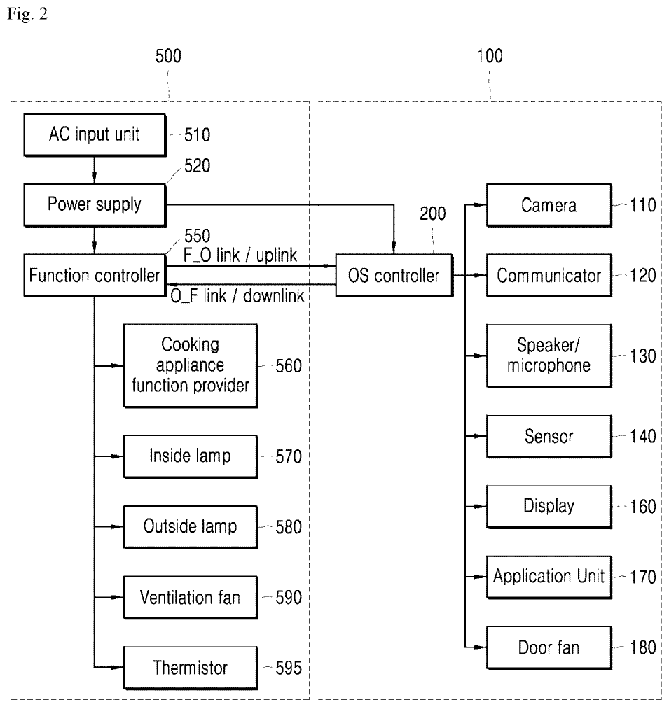

FIG. 2 is a diagram illustrating components of a digital controller door and components of a functional unit (e.g., a main body or main portion of the cooking appliance) according to an embodiment of the present disclosure. Each of the components is conceptually disposed and is not limited to a specific physical location or material.

The digital controller door 100 can operate as an Internet-of-things hub. The digital controller door 100 can include an OS controller 200. In addition, the digital controller door 100 can include a camera 110. In addition, the digital controller door 100 can include a communicator 120. In addition, the digital controller door 100 can include a speaker/microphone 130. In addition, the digital controller door 100 can include a sensor 140. In addition, the digital controller door 100 can include the display 160. In addition, the digital controller door 100 can include an application unit 170. In addition, the digital controller door 100 can include a door fan 180. The door fan can be embodied as a direct current (DC) fan and cools the heat of the digital controller door 100. In particular, the door fan 180 cools heat generated from the display 160.

Hereinafter, the OS controller 200, the camera 110, the communicator 120, the speaker/microphone 130, the sensor 140, the display 160, the application unit 170, and the door fan 180 are referred to as elements or components of the digital controller door 100.

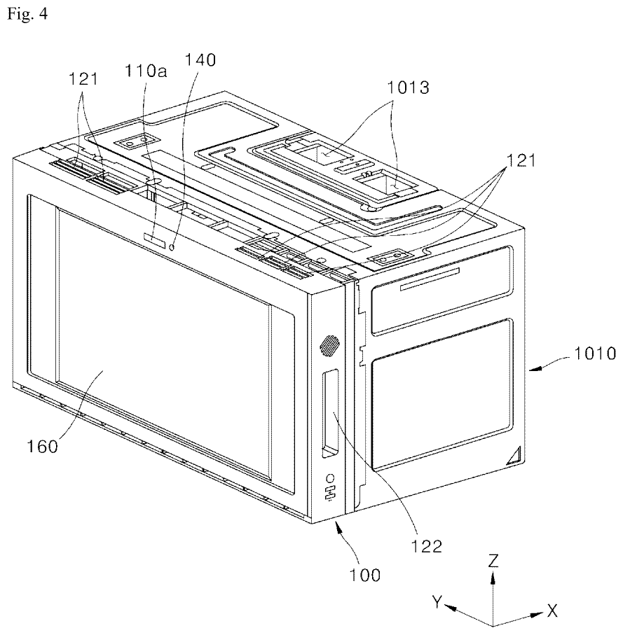

The functional unit 500 (e.g., main body or main portion) includes an AC input unit 510, a power supply 520, a function controller 550, a cooking appliance function provider 560 (e.g., magnetron, microwave generator, heater), an inside lamp 570, an outside lamp 580, a ventilation fan (vent fan) 590, etc. The functional unit 500 (e.g., main body) and the digital controller door 100 (e.g., smart door, or display door) are logically configured for the description of the present disclosure. The functional unit 500 can be implemented as a body 1010 illustrated in FIG. 4. For example, the functional unit 500 can be referred to as a main body or main portion of the cooking appliance. Accordingly, the functional unit 500 can further include various physical components necessary for implementation as the body 1010 in addition to the components illustrated in FIG. 2. According to an embodiment, the functional unit 500 can be referred to as a main body or body portion of a microwave or a cooking appliance, and the digital controller door 100 can be referred to a display door, a smart door or touchscreen door of the cooking appliance.

The OS controller 200 controls various components of the digital controller door 100 (e.g., smart door, touchscreen door or door display, etc.). According to an embodiment, the OS controller 200 of the door can be referred to as a door controller and the function controller 500 can be referred to as a main controller. According to embodiments, the function controller 500 and the OS controller 200 can be referred to in various ways, such as main controller and sub-controller, first controller and second controller, system controller and display controller, or main controller and user interface UI controller, or variations thereof. For example, the controller in the cooking appliance can be referred to as a function controller 550 and the controller in the door can be referred to as display controller.

In addition, the OS controller 200 (e.g., in the door) transmits a predetermined signal to the function controller 550 (e.g., in the microwave oven), and allows the function controller 550 to control the performance of a specific function of the cooking appliance 1000. In addition, the function controller 550 can transmit a signal to the OS controller 200. This allows the function controller 550 to inform the OS controller 200 of a result related to the performance of a specific function of the cooking appliance 1000. The OS controller 200 can operate based on a specific operating system (OS) (e.g., Android). An Android operation system is merely an example, and other types of operating systems can be used, according to embodiments.

According to an embodiment, the function controller 550 and the OS controller 200 can operate independently and can communicate a predetermined signal with each other when there is information to be notified to each other. A type of signal can be based on various communication protocols such as wired communication or wireless communication. According to an embodiment, when the OS controller 200 receives information from the user and is instructed to perform a specific function of the cooking appliance, the OS controller 200 can transmit a specific signal to the function controller 550. In this situation, the function controller 550 operates the functional unit 500 (e.g., main body and components), for example, the body 1010.

The function controller 550 can be embodied as a microcomputer for generating a signal for operating the functional unit 500, for example, the body 1010.

The camera 110 can be disposed on the digital controller door to photograph the outside of the cooking appliance 1000, photograph the surroundings, or photograph a cooking space inside the cooking appliance 1000.

In addition, the camera 110 can be disposed inside the digital controller door 100. The camera 110 can photograph the inside of the cooking appliance 1000 to allow the user to check the cooking state of the food stored therein.

Accordingly, the camera 110 can be disposed to face outwardly of the digital controller door 100 (toward the user) and to face inwardly of the digital controller door 100 (toward the inside of the cooking appliance). In this situation, the display 160 can output an image obtained by photographing the outside out of the cooking appliance or the inside of the cooking appliance based on the cooking state or a state of the function performed by the digital controller door 100.

The communicator 120 (e.g., communication interface, or transceiver) can perform various types of wired or wireless communication functions. The communicator can communicate with another device (e.g., an external server, a hub disposed in a home, or another home appliance) using a communication protocol such as Wi-Fi, BLUETOOTH, or the like.

The speaker/microphone 130 can generate a voice, an alarm sound, etc. necessary for the operation of the cooking appliance 1000, and can receive a predetermined external voice command or an external sound. The speaker/microphone 130 can be integral with each other or can be disposed at different positions.

The sensor 140 senses an environment outside or inside the cooking appliance 1000. For example, the sensor 140 can include a temperature sensor, an illuminance sensor, a human sensor, a humidity sensor, etc.

The display 160 outputs visual information to be provided to a user. The information provided from the display 160 includes a cooking function or state of the cooking appliance 1000 in operation, an interface for controlling the cooking appliance 1000, and information on a surrounding environment in which the cooking appliance 1000 is disposed.

In addition, when the digital controller door 100 operates as an Internet-of-things hub, the display 160 can display various information in addition to cooking related information. In addition, the display 160 can convert a user's touch into an input signal.

The application unit 170 stores therein various application programs as executed by the digital controller door 100, and the OS controller 200 can execute the application programs stored in the application unit 170 and can display the execution results on the display 160. For example, the display 160 can be a touchscreen display.

The door fan 180 embodied as the direct current fan is configured to cool heat generated in various electronic devices related to a digital controller door. The door fan 180 can cool the heat generated from the display 160 and/or the OS controller 200.

The OS controller 200 can download various application programs through the communicator 120 and store and install the application programs in the application unit 170.

The application program according to an embodiment of the present disclosure includes an application program directly or indirectly related to the operation or function of the cooking appliance 1000, such as an application program for controlling the cooking of the cooking appliance 1000, an application program related to an image or a video to be displayed during the operation of the cooking appliance 1000, etc. In this situation, the OS controller 200 can control a function of the cooking appliance 1000 by controlling the function controller 550 using the application program. Alternatively, the OS controller 200 can transmit a signal to the function controller 550 to change the function of the cooking appliance 1000. Alternatively, the OS controller 200 can transmit a signal to the function controller 550 to request that the function of the cooking appliance 1000 be maintained. Alternatively, the OS controller 200 can transmit a signal to the function controller 550 to instruct a specific function of the cooking appliance 1000.

In addition, the application program according to an embodiment of the present disclosure includes an application program for the digital controller door 100 to operate as the Internet of Things hub.

The AC input unit 510 of the functional unit 500 (e.g., main body) receives power for the cooking appliance 1000 to operate. The supplied power is provided to the function controller 550 and the OS controller 200 through the power supply 520.

The function controller 550 controls the functions of the cooking appliance 1000. In this regard, the function controller 550 receives a signal from the OS controller 200 and controls the functions of the cooking appliance 1000. The function controller 550 can control an operation of each of the cooking appliance function provider 560 (e.g., magnetron, microwave generator, heating coil(s), heater), the inside lamp 570, the outside lamp 580, the ventilation fan (Vent Fan) 590, and the thermistor 595 according to the signal received from the OS controller 200. Hereinafter, the cooking appliance function provider 560, the inside lamp 570, the outside lamp 580, the ventilation fan 590, and the thermistor 595 are referred to as elements or components of the functional unit 500.

The cooking appliance function provider 560 (e.g., magnetron, microwave generator, heating coil(s), heater) generates microwaves or heater heat to cook food stored in the cooking appliance 1000.

The inside lamp 570 is disposed inside the cooking appliance 1000 that is opened and closed by the digital controller door 100. When the digital controller door 100 is opened or closed, the inside lamp 570 can be turned on and off. Alternatively, when the cooking appliance 1000 is cooking the food, the inside lamp 570 can be turned on so that the internal camera can capture an image thereof.

The outside lamp 580 is disposed at a lower end or an upper end of the cooking appliance 1000. When the cooking appliance 1000 is disposed on top of a separate cooktop, the outside lamp 580 can be disposed at a lower end of the cooking appliance 1000.

The ventilation fan 590 discharges heat generated from the cooktop to the outside.

The thermistor 595 is a component disposed in the functional unit 500 (e.g., main body and components) to sense a temperature. One or more thermistors 595 can be disposed at the cooking appliance 1000.

According to an embodiment of the present disclosure, the thermistor 595 can provide information on the sensed temperature to the function controller 550. According to another embodiment of the present disclosure, the thermistor 595 can be included in the sensor 140, and in this situation, information on the sensed temperature can be provided to the OS controller 200 that controls the sensor 140.

The food stored in the cooking appliance 1000 is cooked via the operation of the cooking appliance function provider 560. Even in this process, the function controller 550 and the OS controller 200 can communicate information with each other per a preset time interval.

The OS controller 200 provides a user interface/user experience (UI/UX) function. In addition, the OS controller 200 transmits a predetermined signal to the function controller 550, and the function controller 550 controls the operation of the cooking appliance 1000, for example, the body 1010 or the functional unit 500. In addition, the function controller 550 can control an operation of the cooking appliance function provider 560 and provide information generated therefrom during control to the OS controller 200.

Accordingly, the control flow of the OS controller 200 and the function controller 550 is configured such that the OS controller 200 transmits a predetermined signal to the function controller 550 and then receives a predetermined control result from the function controller 550. For example, the OS controller 200 in the door can monitor the function controller 550 in the body of the microwave/cooking appliance.

The OS controller 200 and the function controller 550 can communicate with each other in a wired or wireless manner. The OS controller 200 and the function controller 550 can communicate with each other using various communication protocols, and embodiments of the present disclosure are not limited to a specific communication protocol.

As illustrated in FIG. 2, a communication link via which the function controller 550 transmits predetermined data to the OS controller 200 or performs control is referred to as a F_O link or an uplink. A communication link via which the OS controller 200 transmits predetermined data to the function controller 550 or performs control is referred to as an O_F link or a downlink. However, embodiments of the present disclosure are not limited to a specific name or a direction such as upward/downward, and the links can be distinguished from each other based on a direction of data transmission between the components 550 and 200.

In an embodiment of the present disclosure, the link can physically use one or more lines or can use one or more communication media. In addition, in accordance with the present disclosure, a name is separately given to each data transmission direction in order to distinguish logically the data transmission directions from each other.

According to an embodiment of the present disclosure, in the situation of the wired communication, the OS controller 200 and the function controller 550 can communicate with each other using a communication protocol such as Universal asynchronous receiver/transmitter (UART) and Universal Serial Bus (USB).

According to an embodiment of the present disclosure, in the situation of the wireless communication, the OS controller 200 and the function controller 550 can communicate with each other using a communication protocol such as ZIGBEE, Wi-Fi, and BLUETOOTH.

Each of the OS controller 200 and the function controller 550 can include a separate memory (e.g., internal memory), and can store, in the memory, function result information or error information generated in the process of performing a function.

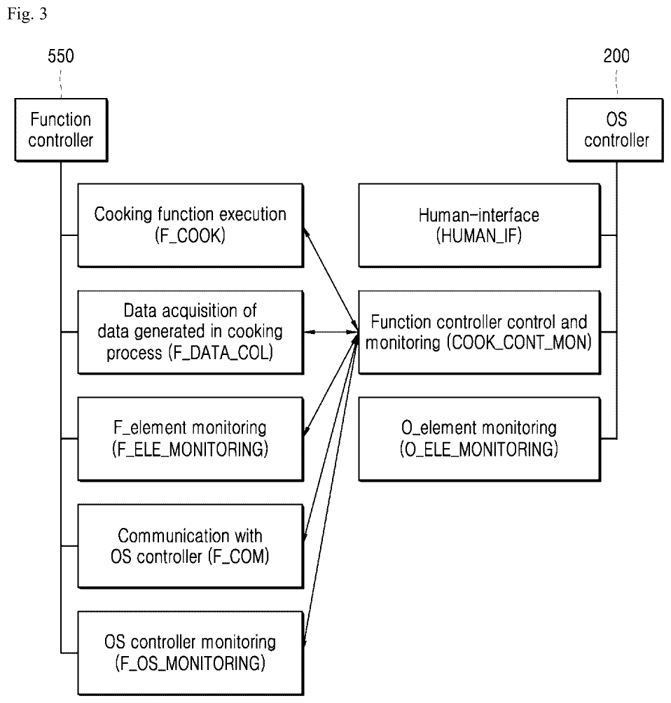

FIG. 3 is a diagram illustrating categories of functions performed by an OS controller and a function controller according to an embodiment of the present disclosure. Each function includes a situation in which each of the controllers 200 and 550 performs a corresponding function.

Each of the controllers 200 and 550 can perform the functions simultaneously or sequentially.

The function controller 550 controls the functional unit 500 that provides a cooking function. The operating system (OS) controller 200 transmits a signal to the function controller 550. The function controller 550 instructs an operation of the functional unit 500. The operating system (OS) controller 200 controls the digital controller door 100 that provides a human interface.

The functions performed by the function controller 550 include cooking function execution F_COOK. In addition, the functions performed by the function controller 550 include data acquisition F_DATA_COL of data generated in the cooking process. In addition, functions performed by the function controller 550 include F_element monitoring F_ELE_MONITORING. In addition, functions performed by the function controller 550 include communication F_COM with the OS controller 200. In addition, functions performed by the function controller 550 include OS controller monitoring F_OS_MONITORING. The OS controller 200 and the function controller 550 can operate independently, and can inform the state or operation status of each component via transmission and reception of signals to and from each other.

In the cooking function execution F_COOK, the function controller 550 controls the cooking appliance function provider 560 so that the cooking appliance 1000 can perform cooking. Alternatively, in addition to cooking such as heating, a function in which the function controller 550 controls the operation of the inside lamp 570, the outside lamp 580, and the ventilation fan 590 can be included in the cooking function execution F_COOK.

The function of the data acquisition F_DATA_COL of the data generated in the cooking process is a function of the function controller 550 collecting or acquiring various result values calculated by the elements or the components of the functional unit 500 or data related to the current state in the cooking function execution F_COOK process.

The F_element monitoring (F_ELE_MONITORING) refers to a function in which the function controller 550 monitors elements or components of the functional unit 500. The function controller 550 can monitor whether each element or component operates properly or whether each element or component operates according to a previous instruction to perform a function.

The communication F_COM function with the OS controller means that the function controller 550 provides data obtained in F_DATA_COL, F_ELE_MONITORING, etc. to the OS controller 200.

The OS controller monitoring F_OS_MONITORING function refers to a function in which the function controller 550 transmits a predetermined packet to the OS controller 200 to check whether the OS controller 200 is operating properly.

The F_COM and F_OS_MONITORING functions can be implemented as one function. That is, even when the cooking function is not performed, the function controller 550 transmits the data obtained through the F_ELE_MONITORING to the OS controller 200. The function controller 550 can check whether the OS controller 200 is in a normal state or an abnormal state based on whether the OS controller 200 has transmitted an acknowledgement (ACK) response to the transmitted data. The normal state can refer to an error free operating state, and the abnormal state can refer to an operating state that includes one or more errors or problems.

The functions performed by the OS controller 200 include a human-interface HUMAN_IF. In addition, the functions performed by the OS controller 200 include function controller control and monitoring COOK_CONT_MON. In addition, the functions performed by the OS controller 200 include O_element monitoring O_ELE_MONITORING. In this regard, one embodiment of the function controller control and monitoring COOK_CONT_MON is that the OS controller 200 transmits a predetermined signal to the function controller 550 so that the function controller 550 can control the functional unit 500, that is, the body 1010.

The human-interface HUMAN_IF function refers to a function in which the OS controller 200 outputs a user interface, such as various information or a menu for controlling the cooking appliance, and receives a user's touch input or user command thereto.

One embodiment of the function controller control and monitoring COOK_CONT_MON is that the OS controller 200 provides a signal to the function controller 550 so that the function controller 550 controls the operation of the functional unit 500, that is, the body 110. In addition, one embodiment of the function controller control and monitoring COOK_CONT_MON is that predetermined information collected by the function controller 550, for example, information for monitoring the state or an operation status of the functional unit 500, that is, the body 110, is transmitted to the OS controller 200 in a form of a predetermined wired or wireless signal.

More specifically, when the user selects a specific cooking function in the human-interface HUMAN_IF function, the OS controller 200 can instruct the function controller 550 to execute the cooking function.

In addition, the OS controller 200 can perform monitoring to receive values of the operation states or cooking results of the elements or the components constituting the functional unit 500 from the function controller 550. All of these functions are included in the function controller control and monitoring COOK_CONT_MON. Accordingly, the function controller control and monitoring COOK_CONT_MON of the OS controller 200 is related to five functions of the function controller 550.

The O_element monitoring O_ELE_MONITORING refers to a function in which the OS controller 200 monitors the elements or the components of the digital controller door 100. The OS controller 200 can monitor whether each of the elements or the components operates properly, or whether each element or component operates according to a previous instruction to perform a function.

As shown in FIG. 3, the function controller 550 and the OS controller 200 perform respective given functions independently but in association with each other. Accordingly, the function controller 550 checks whether the OS controller 200 operates normally or not in the process of performing the function, while the OS controller 200 checks whether the function controller 550 operates normally or not in the process of performing the function. When an abnormality or error occurs in a component of one of the function controller 550 and the OS controller 200, the other of the function controller 550 and the OS controller 200 can cope with this situation or address the abnormality or error.

Hereinafter, a schematic outer appearance and configuration of a cooking appliance including the digital controller door 100 of the present disclosure will be described. This corresponds to one embodiment of the present disclosure, and a scheme and a direction in which the digital controller door 100 is opened can be implemented in various ways.

The present disclosure relates to a scheme for controlling a cooking appliance using a digital controller door disposed at a front surface of the cooking appliance.

According to the present disclosure, a door of a microwave oven disposed on top of an oven or a gas stove acts as an LCD screen (an embodiment of a display). The Android board (an embodiment of an OS controller) of the LCD screen and the microcomputer (an embodiment of a function controller) of the microwave oven cooperate with each other. An LCD component operates according to various operating/external environments of the microwave oven or controls a specific function of the microwave oven.

The digital controller door (e.g., door controller, or smart door) of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD providing various user interfaces such as a touch screen, and is capable of storing and cooking food therein.

A display can be mounted on a front surface of a digital controller door provided in the cooking appliance of the present disclosure to provide various information to a user. The user can know the cooking state of the cooked food on the display.

In addition, when the display is connected to another home appliance to serve as a hub of the home appliances, the information other than cooking food can be obtained through the display. In addition, a command for cooking and various other commands can be input to the display in a touch manner.

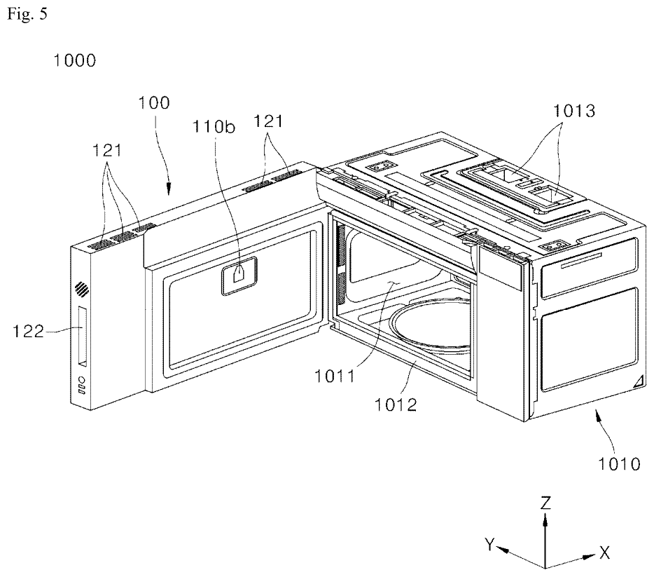

FIG. 4 is a perspective view illustrating a cooking appliance according to an embodiment of the present disclosure. FIG. 5 is a diagram illustrating a state in which the digital controller door 100 is opened in FIG. 4.

The cooking appliance according to the embodiment can be disposed at a position spaced apart from the heating cooking device in the vertical direction above a position where a heating-type oven, a gas stove, etc. are disposed.

Due to the arrangement of the cooking appliance, a user can conveniently use the heating cooking device including the cooking appliance. In addition, the cooking appliance can serve as a hood of the heating cooking device disposed under the cooking appliance. In this situation, the cooking appliance can include components for use as the hood.

The cooking appliance can cook food using microwaves belonging to electromagnetic waves and/or heater heat. The cooking appliance can include the body 1010 in which a cavity 1011 is formed, and the digital controller door 100 configured to open and close the cavity 1011. The body 1010 is an embodiment of the functional unit 500 of FIG. 2 as described above. According to an embodiment of the present disclosure, the body 1010 can act in the same manner as the functional unit 500 can. Alternatively, according to an embodiment of the present disclosure, the components of the functional unit 500 can be implemented in the body 1010. Accordingly, in various embodiments, the functional unit 500 and the body 1010 can be interchangeable with each other.

Food to be cooked can be placed in the cavity 1011. The digital controller door 100 can be disposed in front of the cavity 1011 and pivotally mounted at the body 1010 to open and close the cavity 1011.

A ventilation hole 1013 for discharging air suctioned from a suction unit provided at a lower portion of the body 1010 to the outside can be provided at an upper portion of the body 1010. A suction unit can be provided at a lower portion of the body 1010 of the cooking appliance. Accordingly, the cooking appliance can serve as a hood that sucks air discharged from the heating cooking device disposed below the cooking appliance and discharges the air to the outside.

The body 1010 can further include a front panel 1012 provided along an edge of an inlet of the cavity 1011. One surface of the front panel 1012 faces one surface of a choke member when the digital controller door 100 is closed, thereby closing the cavity 1011.

The front panel 1012 can be constructed to surround the edge of the inlet of the cavity 1011 and protrude in a frontward direction and has a predetermined width. Accordingly, when the digital controller door 100 is closed, the edge portion of the digital controller door 100 and the cavity 111 can overlap each other.

Due to this structure, the front panel 1012 can seal the cavity 1011 in a state in which the digital controller door 100 has been closed, thereby preventing oil, moisture, oil vapor, etc. generated during the cooking process of the food placed in the cavity 1011 from being leaked out to the outside through the inlet of the cavity 1011.

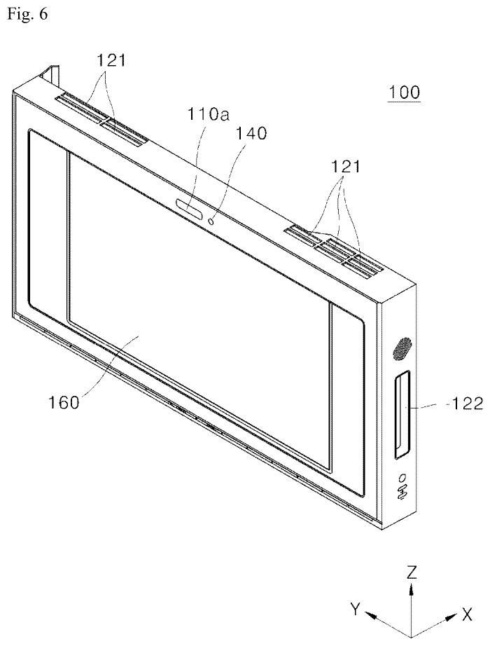

FIG. 6 is a perspective view illustrating a digital controller door of a cooking appliance according to an embodiment of the present disclosure.

The digital controller door 100 (e.g., display door) can include controller hardware (e.g., a hardware chip) or controller software (software including programs) that executes a predetermined algorithm and performs following tasks based on sensing results from various sensors disposed at the cooking appliance or the door and an operating state of the cooking appliance.

In FIGS. 4 to 6, a reference numeral 121 denotes a through hole through which air is introduced or discharged. A first camera 110a and the sensor 140 can be disposed on the front surface of the digital controller door 100. The sensor 140 includes a human sensor, an illuminance sensor, etc.

The display 160 is used to control the cooking appliance 1000 or displays an operation process in the cooking appliance 1000. The ventilation hole 1013 can include a suction portion defined at a lower end of the body 1010 and a discharge portion defined at an upper end of the body 1010. A handle 122 is disposed on one side of the digital controller door 100 such that the user can open and close the digital controller door 100 using the handle.

A second camera 110b can be disposed on an inner side surface of the digital controller door 100, and the second camera 110b can photograph the inside of the cavity 1011 to check the cooking state.

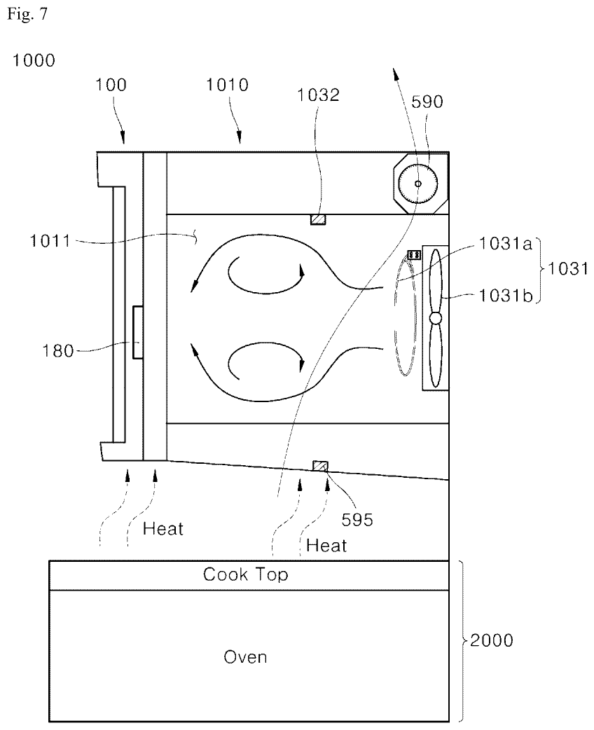

FIG. 7 is a schematic view illustrating a position where a cooking appliance is disposed according to an embodiment of the present disclosure. In FIG. 7, the flow of air is indicated by a solid line arrow, and the transfer direction of heat is indicated by a dashed line arrow. A heating cooking device 2000 can include, for example, an oven and a cooktop disposed on top of the oven.

The cooking appliance can include a convection-based heating device 1031 and a microwave generating device 1032 to heat food accommodated in the cavity 1011.

The convection-based heating device 1031 can generate heat to heat food, and the microwave generating device 1032 can generate microwaves to heat food. The user can select and operate one of the convection-based heating device 1031 or the microwave generating device 1032 to heat and cook food.

The convection-based heating device 1031 can include a convection heater 1031a and a convection fan 1031b. The convection heater can generate heat to heat food accommodated in the cavity 1011. The convection fan 1031b can force the air in the cavity 10 11 heated by the convection heater 1031a to flow in the cavity 1011.

When the convection fan 1031b operates, the heated air can be smoothly convectively circulated in the cavity 1011, and accordingly, heat is uniformly supplied to the entire cavity 10 11, so that an entirety of the food accommodated in the cavity 1011 can be evenly cooked.

In order to prevent the display 160 provided in the digital controller door 100 from being overheated by the heated air coming up from the heating cooking device disposed under the cooking appliance, resulting in malfunction of or damage to the display 160, it is necessary to cool the display 160 and prevent external heat from being transferred to the display 160. The door fan 180 and the ventilation fan 590 can perform the above role.

The door fan 180 can be disposed inside the digital controller door 100 (e.g., the door fan can be inside the smart display door). The door fan 180 can effectively cool the display 160 by flowing air toward the rear surface of the display 160.

In addition, the air flow discharged from the door fan 180 to the outside of the digital controller door 100 (e.g., display door) can form an air curtain to block the heat rising from the heating cooking device disposed under the cooking appliance.

The ventilation fan 590 can be disposed at a top of the body 1010 and can be disposed in a flow path of the ventilation hole 1013. The ventilation fan 590 can allow air coming up from the heating cooking device to flow to the ventilation hole 1013 to discharge the air to out of the cooking appliance.

Accordingly, when the ventilation fan 590 operates, a significant portion of the heated air coming up from the heating cooking device flows to the ventilation hole 1013 formed in the body 1010, and the flow rate of air heading to the display 160 of the digital controller door 100 can be relatively reduced. As a result, the flow rate of the heated air directed to the display 160 of the digital controller door 100 (e.g., display door) is reduced, thereby suppressing overheating of the display 160.

In order to block overheating of the display 160, can be desirable to appropriately use the door fan 180 and the ventilation fan 590. Since one of main purposes of the door fan 180 is to prevent the overheating of the display 160, the door fan 180 can operate in a low-speed rotation mode and a high-speed rotation mode based on the temperature condition of air approaching the digital controller door 100.

The door fan 180 has a small amount of air blown in the low-speed rotation mode and a large amount of air blown in the high-speed rotation mode. Therefore, the temperature of the display 160 can be effectively lowered by the door fan operating in the low-speed rotation mode when the temperature of the air is low and by the door fan operating in the high-speed rotation mode when the temperature of the air is high.

In order to reliably suppress the overheating of the display 160, it is advantageous to operate both the door fan 180 and the ventilation fan 590 and operate the door fan 180 in the high-speed rotation mode.

The thermistor 595 disposed at a bottom of the cooking appliance 1000 can sense the heat from the heating cooking device disposed under the cooking appliance 1000. In addition, the auto ventilation function can operate upon sensing the heat.

According to an embodiment of the present disclosure, one button can be disposed on a side or front surface of the digital controller door 100. This button can be used when the user turns off the display 160, turns off the digital controller door 100, or turns off the entire cooking appliance 1000 (e.g., on/off button, power off button).

The cooking appliance 1000 heats the food and is likely to receive heat from another heating cooking appliance such as a cooktop adjacent thereto or below the cooking appliance 1000. Therefore, the cooking appliance 1000 should operate safely. In addition, it is sometimes necessary to display the operating state of the cooking appliance 1000 on the digital controller door 100 so that the user can grasp the operating state of the cooking appliance 1000.

Therefore, in the present disclosure, a power-off process of the digital controller door 100 of the cooking appliance 1000 and operation control of components according thereto will be described.

That is, in the present disclosure, a process and a method of controlling the power-off of the digital controller door 100 of the cooking appliance 1000 including the function unit 500 providing a cooking function and the digital controller door 100 instructing the operation of the function unit 500 and providing a human interface will be described.

The digital controller door 100 can perform two different types power-off modes, according to an embodiment. The first power-off mode is a hard power-off mode in which the OS controller 200 is powered off. In addition, other components of the digital controller door 100 can be powered off. The second power-off mode is a soft power-off mode in which only the display 160 is turned off while the OS controller 200 is maintained in a turned-on state.

According to an embodiment of the present disclosure, the components included in the digital controller door 100 can receive power through the OS controller 200 (e.g., display door controller, or door controller). In this situation, when the OS controller 200 is powered off in the hard power-off mode as the first power-off mode, other components are also powered off. For example, when the supply of power applied to the OS controller 200 is cut off in the hard power-off process, the OS controller 200 is powered off. Accordingly, other components of the digital controller door 100 supplied with power through the OS controller 200 are also powered off.

According to another embodiment of the present disclosure, the components included in the digital controller door (e.g., in the smart display door) can be supplied with power independently of the OS controller 200 (e.g., smart door controller). In this situation, in the first power-off mode, that is, the hard power-off mode, the OS controller 200 can be powered off, while other components included in the digital controller door may not be powered off. Alternatively, when the OS controller 200 is powered off, the OS controller 200 can instruct some or all of the components included in the digital controller door to be powered off.

In summary, the operating system (OS) controller 200 (e.g., door controller) that controls the digital controller door 100 can perform the hard power-off mode or the soft power-off mode in response to one of a selection of a power-off menu of the human interface, manipulation of a button disposed on the digital controller door 100, or a monitoring result of components of the digital controller door 100.

In the hard power-off mode, the OS controller 200 (e.g., door controller) powers off all components of the digital controller door 100. In the soft power-off mode, the OS controller 200 powers off the display 160 of the digital controller door 100.

The user can use a physically formed button for the power-off according to an embodiment. When the button disposed on the digital controller door 100 is manipulated in a first manner, the OS controller 200 can perform an imperative hard power-off mode.

When the button is manipulated in a second manner, the OS controller 200 can perform an optional soft power-off mode. Depending on a time duration for which the button has been pressed or the number of times the button is repeatedly pressed, the first/second manners can be distinguished from each other, such that the hard power-off mode or the soft power-off process is performed.

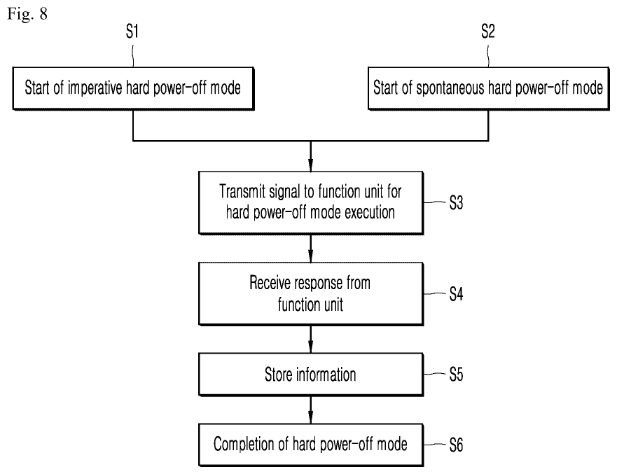

FIG. 8 is a diagram illustrating a process in which the digital controller door (e.g., smart door, door, or display door, etc.) is hard-powered off according to an embodiment of the present disclosure.

According to an embodiment of the present disclosure, when the user presses the button disposed on the digital controller door 100 in the first manner or the user selects the power-off of the digital controller door 100 using the user interface displayed on the display 160, the digital controller door 100 executes the hard power-off mode. This is referred to as the imperative hard power-off.

The first manner according to an embodiment of the present disclosure can include any one of a long press manner in which a button is pressed for a long time, a manner in which a button is pressed for a short time repeatedly N times or greater, or a combination manner in which a long press and a short press are combined with each other one or more times.

According to another embodiment of the present disclosure, the OS controller 200 can check external environmental factors (e.g., temperature, smoke, etc.) and accordingly, can hard power-off the digital controller door 100. This is referred to as a spontaneous hard power-off mode. For example, in unsafe environmental conditions, the digital controller door 100 (e.g., display door) can turn itself off automatically (e.g., spontaneous hard power-off mode)

As shown in FIG. 8, the imperative hard power-off mode can be started by the user in S1. Alternatively, the OS controller 200 can start the spontaneous hard power-off mode in S2.

Since each of the operations S1/S2 turns off all components of the digital controller door 100 (e.g., display door), the OS controller 200 (e.g., door controller) transmits a signal to the components of the function unit 500 (e.g., main body and components) of the cooking appliance 1000 in S3. For example, when the function unit 500 is cooking food, the OS controller 200 can transmit a signal instructing the function controller 550 of the function unit 500 to cancel cooking (e.g., turn-off the microwave generator, etc.).

In addition, in the hard power-off mode, the OS controller 200 (e.g., door controller) can transmit a predetermined off command signal to the components (e.g., magnetron, fan, lamp, turntable, etc.) of the function unit 500 and then terminate the operation thereof without receiving a response thereto. For example, the OS controller 200 can transmit a signal instructing cancelation of cooking performed by the function unit 500 or an off command signal of the ventilation fan, and then perform the hard power-off mode even in when there is no response received therefrom.

When the cooking cancelation is instructed from the OS controller (e.g., door controller) 200, the function controller 550 (e.g., microwave oven controller) cancels the operation of the cooking appliance function provider 560. In addition, the OS controller 200 can instruct the function controller 550 to turn off various components (e.g., inside lamps, outside lamps, ventilation fans, etc.) of the function unit 500.

The OS controller 200 transmits a signal to the function controller 550 to the function unit 500 in S3, and then receives a response from the function unit 500 in S4. The response can be received in a wired or wireless manner from the function controller 550. The OS controller 200 checks whether the cooking performed by the cooking appliance function provider 560 is canceled or whether the operation of each of the other components of the function unit 500 is stopped.

In S5, the OS controller 200 stores, in the internal memory, information related to the termination of the operation of the components that were performing the operation, the reason why the hard power-off mode occurs (information on the temperature rise or the error of the electronic element in the situation of the spontaneous hard power-off mode), and the state before the hard power-off mode. For example, a log report can be stored before the powering off operation is completed.

When the digital controller door 100 (e.g., door part, display door) is brought into a power-on state later, the OS controller 200 (e.g., door controller) can display some of the information stored in the memory in the S5 process on the display 160. Then, the OS controller 200 completes the hard power-off mode in S6.

In response to the OS controller 200 no receiving a response to the control instruction sent to the function unit 500 from the function controller 550 in the S4 due to a communication error etc., the OS controller 200 can wait for a time duration for which the function controller 550 shuts down the function unit 500 and then proceed to the operations S5 and S6.

The function controller 550 can confirm an error situation in response to it failing to receive a packet instructing monitoring and control within a predetermined time duration (e.g., error determination time duration) from the OS controller 200. In addition, the function controller 550 can cancel and terminate the operation of the function unit 500 in the error situation.

Accordingly, the OS controller 200 can display on the display 160 that a power-off process is currently being performed until information related to the termination of the operation of the function units 500 is received from the function controller 550.

Alternatively, the OS controller 200 can display on the display 160 that the power-off process is currently being performed until the error determination time duration by the function controller 550 has elapsed.

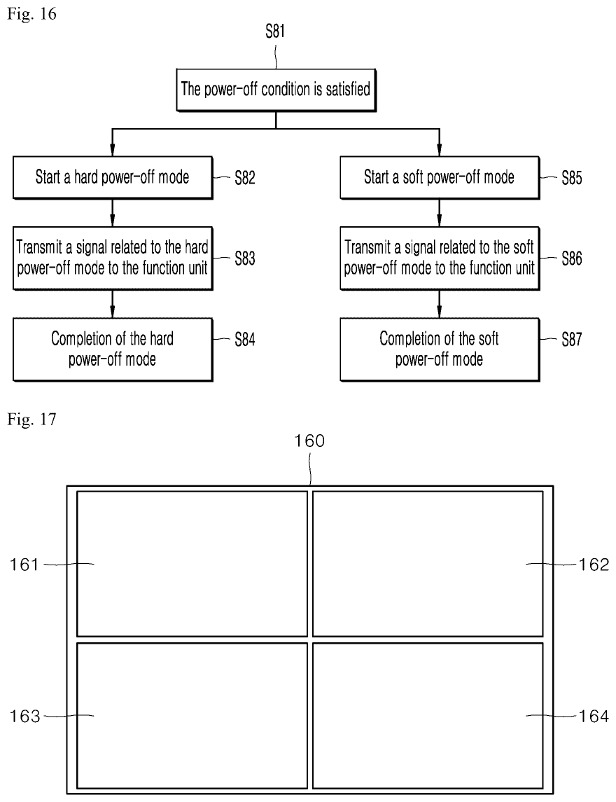

In one example, the operation S4 can be optionally performed. That is, the OS controller 200 can transmit a signal related to the hard power-off mode to the function unit 500 (e.g., main body parts of the cooking appliance), and then store the information in S5 without receiving a separate response from the function unit 500 and then can immediately complete the hard power-off mode in S6. This process will be described with reference to FIG. 16 which will be described later.

A process in which the OS controller 200 (e.g., door controller) controls the operations of the components of the function unit 500 (e.g., main body and parts of the cooking appliance) in detail in the hard power-off process or a process in which the above process is displayed on the display 160 will be described later.

Next, the soft power-off mode will be described.

According to an embodiment of the present disclosure, when a user presses a button disposed on the digital controller door 100 in the second manner or when the user selects power-off of the display 160 using a user interface displayed on the display 160, the digital controller door 100 enters a soft power-off state. Alternatively, when there is no need to turn on the display 160 or no need to keep the display 160 on, the OS controller 200 can turn off the display 160 (e.g., such as entering an idle mode or power saving mode, etc.). This is referred to as an optional soft power-off mode.

The second manner according to an embodiment of the present disclosure can include one of a short press manner in which a button is pressed for a short time, a manner in which a button is pressed for a short time repeatedly M times or greater, or a combination manner in which a short press and a long press are combined with each other one or more times.

According to another embodiment of the present disclosure, the OS controller 200 (e.g., door controller) can determine that a problem has occurred in the operating state of the display 160 and turn off only the display 160 to solve the problem (e.g., reset the display only). As a result, the digital control door 100 is brought into a soft power-off state. This is referred to as error-solving soft power-off mode.

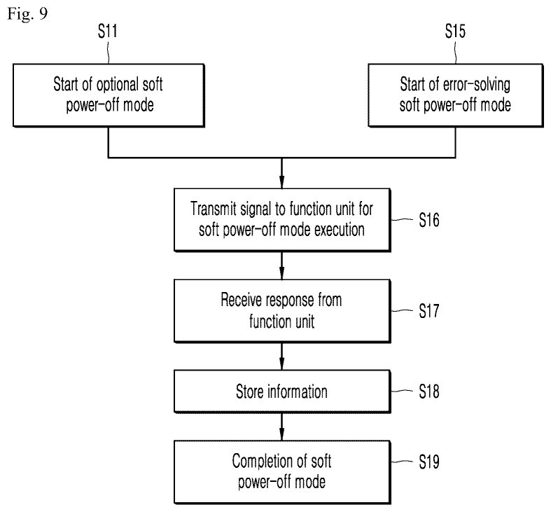

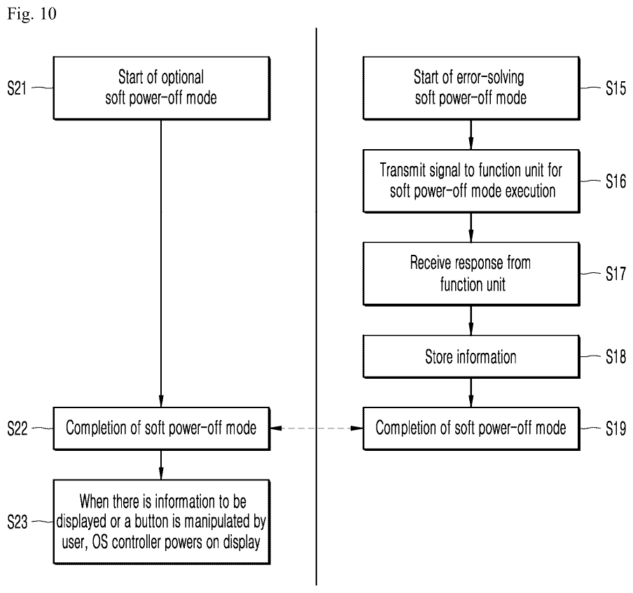

Hereinafter, an operation process of the OS controller in the soft power-off mode will be described. FIG. 9 illustrates an embodiment in which the cooking appliance processes the optional soft power-off mode and the error-solving soft power-off mode in the same manner when they occur according to an embodiment of the present disclosure. FIG. 10 illustrates an embodiment in which a cooking appliance processes the optional soft power-off mode and the error-solving soft power-off mode in different manners when they occur according to another embodiment of the present disclosure.

FIG. 9 is a diagram illustrating a process in which the digital controller door is soft-powered off according to an embodiment of the present disclosure.

The user starts the optional soft power-off mode in S11. This mode refers to a mode in which the user temporarily turns off only the power of the display 160. Alternatively, when it is determined that an error occurs in the display 160 or an operation problem occurs therein, the OS controller 200 starts the error-solving soft power-off mode in S15 (e.g., the door controller can automatically turn off the display only to reset the display).

In the S15, the OS controller 200 can determine that it is necessary to temporarily power-off the display 160 due to an external environment (e.g., temperature, smoke, moisture, etc.). In this situation, the OS controller 200 starts the error-solving soft power-off mode for powering off only the display 160 in S15.

In both the S11 and the S15, since the display 160 cannot operate, the OS controller 200 transmits a signal to the components of the function unit 500 (e.g., main body parts) of the cooking appliance 1000 in S16. For example, when the function unit 500 is cooking food, the OS controller 200 (e.g., door controller) can transmit a signal instructing the function controller 550 (e.g., main controller, or oven controller) of the function unit 500 to cancel cooking. In addition, the OS controller 200 can instruct the function controller 550 to selectively turn off various components (e.g., inside lamp, outside lamp, ventilation fan, microwave generator, etc.) of the function unit 500.

In addition, in the soft power-off mode, the OS controller 200 can transmit a predetermined off command signal to the components of the function unit 500 and then terminate the operation thereof without receiving a response therefrom. For example, the OS controller 200 can transmit a signal instructing cancelation of cooking performed by the function unit 500 or an off command signal of the ventilation fan, and then proceed with the soft power-off mode even when no response is received therefrom.

That is, since an error has occurred in the display 160, the OS controller 200 (e.g., door controller) can instruct the function controller 550 (e.g., main controller/oven controller) to cancel the ongoing cooking and to turn off the inside lamp 570, e.g., an oven lamp, disposed inside the cavity 1011. In another embodiment of the present disclosure, the OS controller 200 can instruct the function controller 550 to maintain the operation of the ventilation fan 590.

Similarly, the OS controller 200 can instruct the function controller 550 to maintain the operation (the turned on state) of the outside lamp 560, e.g., the cooktop lamp disposed at the lower end of the cooking appliance 1000 and located on top of the cooktop 2000. Since the operation of the ventilation fan 590 or the cooktop lamp is related to the function of the cooktop 2000 located under the cooking appliance 1000 and improving safety, rather than the function related to the cooking of the cooking appliance 1000, the operation of these components can be maintained.

The OS controller 200 (e.g., door controller) transmits a signal to the function controller 550 (e.g., oven controller) to the function unit 500 (e.g., main oven parts/body) in S16, and then receives a response from the function unit 500 in S17. The response is received in a wired or wireless manner from the function controller 550. The OS controller 200 checks whether the cooking performed by the cooking appliance function provider 560 is canceled or whether the operation of the other components of the function unit 500 is stopped.

The OS controller 200 stores, in the internal memory, information related to the termination of the operation of the components that were performing the operation, the reason why the soft power-off mode has occurred (e.g., information on an error occurring in the display, such as a temperature rise of the display or a touch recognition failure), and the state before the soft power-off mode in S18. For example, a shutdown log can be stored before it is powered off.

When the display 160 is brought back into a power-on state later, the OS controller 200 can display some of the information stored in the S18 on the display 160. The OS controller 200 completes the soft power-off mode of turning off the display 160 in S19.

In response to the OS controller 200 not receiving a response to the control of the functional unit from the function controller 550 in the S16 due to a communication error etc., the OS controller 200 can wait for a time duration for which the function controller 550 shuts down the functional unit 500 and then proceed to operations S18 and S19.

The function controller 550 can confirm an error situation when it fails to receive a packet that performs monitoring or instructing control within a predetermined time duration (error determination time duration) from the OS controller 200. In this response, the function controller 550 can cancel and terminate the operation of the function unit 500 in the error situation.

Accordingly, the OS controller 200 can display on the display 160 that a power-off process is currently being performed until information related to the termination of the operation of the function units 500 is received from the function controller 550 (e.g., a notification message such as “powering off . . . ” or “shut down in process”).

Alternatively, the OS controller 200 can display on the display 160 that the power-off process is currently being performed until the error determination time duration by the function controller 550 has elapsed.

The operation S17 can be optionally performed. That is, the OS controller 200 can transmit a signal related to the soft power-off mode to the function unit 500, and can store information in S18 without receiving a separate response from the function unit 500 and then can immediately complete the soft power-off mode in S19. This process will be described with reference to FIG. 16 which will be described later.

A process in which the OS controller 200 (e.g., door controller) controls the operations of the components of the function unit 500 (e.g., main body parts) in detail in the soft power-off process or a process in which the above process is displayed on the display 160 will be described later.

FIGS. 8 and 9 illustrate a process in which the OS controller 200 (e.g., door controller) transmits a signal to the function controller 550 (e.g., oven controller) to cancel cooking of the function unit 500 in order to perform the hard power-off mode or the soft power-off mode. The OS controller 200 can transmit a signal instructing the function controller 550 to cancel the cooking of the function unit 500. Alternatively, the OS controller 200 can transmit a signal requesting the function controller 550 to cancel the cooking of the function unit 500. Alternatively, the OS controller 200 can transmit a signal for controlling cooking cancelation of the function unit 500 to the function controller 550. Alternatively, the OS controller 200 transmits a signal notifying the function controller 550 of the cooking cancelation of the function unit 500.

FIG. 10 is a diagram illustrating a process in which a digital controller door (e.g., door, display door, smart door, etc.) is soft-powered off according to another embodiment of the present disclosure. FIG. 10 illustrates an embodiment in which the operation of the functional unit (e.g., main body and components) is not controlled in the optional soft power-off mode, unlike FIG. 9.

The optional soft power-off process will be described. The user starts the optional soft power-off mode in S21. The user can temporarily turn off only the power of the display 160. Since the display 160 can be brought into the power-on state at any time, the OS controller 200 completes the soft power-off mode of turning off only the power of the display 160 in S22.

Since only the power of the display 160 is turned off, each component of the function unit 500 continues to perform the performed function. Similarly, each of the components of the digital controller door 100 other than the display 160 continues to perform the performed function (e.g., fans, lamps, etc.).

When there is information to be displayed on the display 160, such as when cooking has been completed, or when a button is manipulated by the user, the OS controller 200 powers the display 160 back on in S23 and operates the display 160. In this regard, the button manipulation includes a manipulation such as pressing the button in a manner in which the optional soft power-off mode is started (in the second manner, e.g., a short press).

The process S15 to S19 of the error-solving soft power-off mode is the same as that as described in FIG. 9, and thus, can refer to the description of FIG. 9.

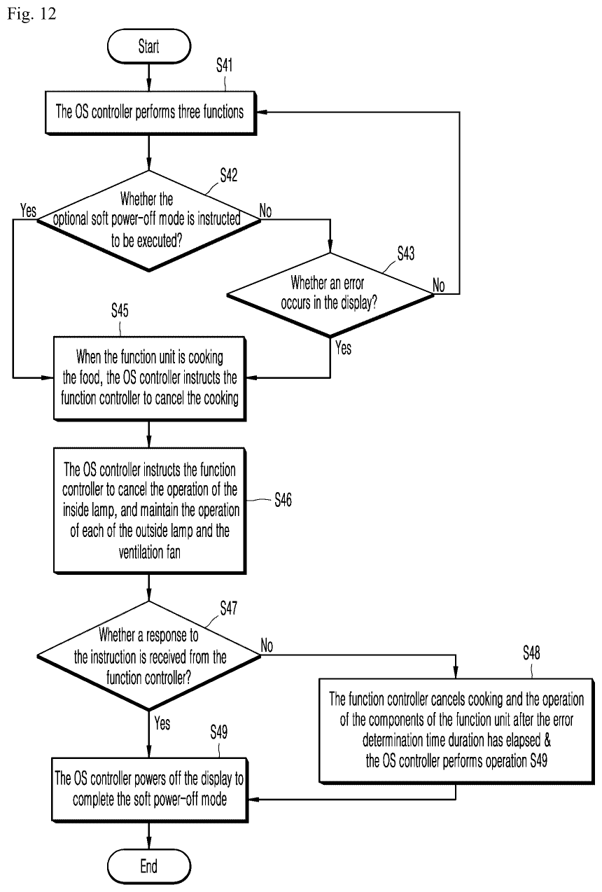

When implementing S21 to S23 of an embodiment of FIG. 10, the OS controller 200 can proceed to operation S49 immediately after S42 of FIG. 12 to be described later. A process S21 to S23 of FIG. 10 is about an embodiment in which the OS controller 200 performs the optional soft power-off mode while maintaining the operation of the functional unit 500.

In this situation, when the operation of the function unit 500 ends, when there is information to be output to the display 160, or when a button manipulation by the user occurs, the OS controller 200 (e.g., display door controller) automatically powers the display 160 back on. As a result, the user can check the information thereon.

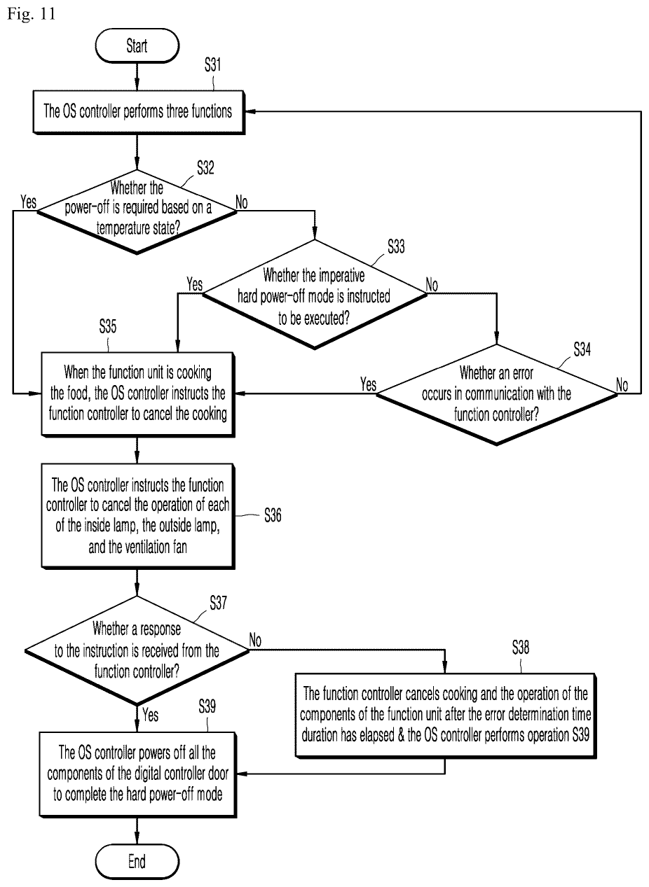

FIG. 11 is a diagram illustrating a process in which an OS controller operates or controls other components in a hard power-off process according to an embodiment of the present disclosure.

The OS controller 200 performs main three functions in S31. As described above with reference to FIG. 3, the OS controller 200 can perform functions of the human-interface HUMAN_IF, the function controller control and monitoring COOK_CONT_MON, and the O_element monitoring O_ELE_MONITORING. The OS controller 200 can perform these functions sequentially or in parallel with each other.

In an embodiment, the OS controller 200 can receive information on the temperature sensed by the thermistor 595 from the function controller 550 in the function controller control and monitoring COOK_CONT_MON process. In addition, the OS controller 200 can check the internal temperature of the digital controller door 100 detected by the sensor 140 in the O_ELE_MONITORING process. All of these correspond to a process in which the OS controller 200 checks the temperature state and determines whether the power-off is required based on the checking result in S32 (e.g., if the display door become too hot and danger of overheating).

For example, the OS controller 200 (e.g., door controller) can determine whether the temperature sensed by the thermistor 595 is higher than a preset temperature T1. In addition, the OS controller 200 can determine whether the temperature sensed by the temperature sensor included in the sensor 140 is higher than a preset temperature T2.

The OS controller 200 determines whether the temperature state requires the hard power-off mode based on the checking result in S32. In response to the hard power-off mode being required in S32—Yes, the OS controller 200 performs operation S35 (e.g., turn off cooking).

When, based on the checking result, the temperature state does not require the hard power-off mode in S32—No, the OS controller 200 performs operation S33.

The OS controller 200 checks whether the imperative hard power-off mode is instructed to be executed through the human-interface HUMAN_IF in S33 (e.g., turn-off instruction received from the user via a touchscreen UI, such a virtual button). Alternatively, the OS controller 200 checks whether the imperative hard power-off mode execution is instructed by the user pressing a specific button (e.g., a physical off button) disposed on the digital controller door 100 in the first manner, for example, the long press manner in S33.

When the imperative hard power-off mode execution is instructed in operation S33 (S33—Yes), the OS controller 200 performs operation S35. When the imperative hard power-off mode is not instructed in operation S33 (S33—No), the OS controller 200 performs operation S34.

The OS controller 200 checks whether an error occurs in communication with the function controller 550 based on the function controller control and monitoring COOK_CONT_MON in S34 (e.g., has communication with the main/oven controller been lost?).

According to an embodiment of the present disclosure, the OS controller 200 can identify a state in which an error occurs in the F_O link (uplink) and information is not received from the function controller 550. In this situation, the OS controller 200 can send a predetermined control instruction to the function controller 550, but may not receive a response thereto from the function controller 550.

In addition, according to another embodiment of the present disclosure, the OS controller 200 can identify a state in which an error occurs in the O_F link (downlink), and thus the function controller 550 cannot receive a packet related to control or monitoring from the OS controller 200.

In this situation, the OS controller 200 repeatedly transmits a packet requesting monitoring or control to the function controller 550, but does not receive a result or response to the control/monitoring request as transmitted by the OS controller 200 from the function controller 550.

Alternatively, the OS controller 200 can determine that an error has occurred in either or both of the F_O link (uplink) and the O_F link (downlink).

When the OS controller 200 has confirmed that an error has occurred in S34, the OS controller 200 can perform operation S35 (e.g., shut down the microwave oven components). In response to it determining that no error has occurred in the S34, the OS controller 200 can proceed back to operation S31.

The execution process of the hard power-off mode of S35 to S39 will be described in detail.

When the function unit 500 is cooking the food (that is, when the cooking appliance function provider 560 is operating), the OS controller 200 (e.g., door controller) instructs the function controller 550 (e.g., oven controller) to cancel the cooking in S35. The cooking cancelation includes terminating the operation of the cooking appliance function provider 560. In the hard power-off mode, the user may no longer control the cooking appliance, so that all operations of the cooking appliance are terminated.

In addition, the OS controller 200 (e.g., door controller) instructs the function controller 550 (e.g., oven controller) to cancel the operation of each of the inside lamp 570, the outside lamp 580, and the ventilation fan 590 in S36.

The OS controller 200 (e.g., door controller) determines whether a result or response to the instruction of the S35 and the S36 is received from the function controller 550 in S37.

When there is no error in the communication state between the OS controller 200 (e.g., door controller) and the function controller 550 (e.g., main/oven controller), the function controller 550 cancels the cooking and cancels the operations of the lamps and the ventilation fan according to the instruction of S35/S36. The OS controller 200 receives a packet including a result or response indicating that the instruction of the S35/S36 has been performed from the function controller 550 in S37—Yes).

After confirming that the operation of the components constituting the function unit 500 has ended, the OS controller 200 powers off all the components of the digital controller door 100 to complete the hard power-off mode in S39. For example, the display door controller can wait until all the components of the microwave oven have shut down before shutting itself down.

In response to the result or response to the instruction not being received in S37—No, e.g., in response to a communication error occurring in S34, the function controller 550 cancels cooking and the operation of the components of the function unit after the error determination time duration has elapsed due to the inability to communicate with the OS controller 200 in S38. For example, if the oven controller does not hear from the door controller for a predetermined amount of time, then the oven controller can shut down itself and the components of the oven, in order to enhance safety.

The OS controller 200 (e.g., door controller) does not receive a separate response to the instruction from the function controller 550 (e.g., oven controller) due to the communication problem. However, since the function controller 550 terminates the function of the function unit 500 by itself in the communication error situation, the OS controller is configured to perform the operation S39 to complete the hard power-off mode.

In another embodiment of the present disclosure, in response to an error occurring in communication with the functional controller, the OS controller 200 can immediately proceed to the operation S39. In this situation, when it is determined in the operation S34 that the error occurs in communication with the function controller 550 (Yes in S34), the OS controller 200 can proceed to the operation S39. However, this process can vary depending on whether the communication error has occurred in the uplink or the downlink. In this situation, the OS controller can perform the process S35 to S39 when it is determined in operation S34 that the error occurs in communication with the function controller 550 (Yes in S34).

In summary, in the event of the error occurrence in the operation S34, according to an embodiment of the present disclosure, the OS controller 200 can perform the process S35 to S39 according to a predefined process.

Alternatively, in the event of the error occurrence in the operation S34, according to another embodiment of the present disclosure, the OS controller 200 can perform only the operation S39.

FIG. 12 is a diagram illustrating a process in which an OS controller operates or controls other components in a soft power-off process according to an embodiment of the present disclosure. The embodiment of FIG. 9 will be described in more detail.

The OS controller 200 performs three main functions in S41. As described above with reference to FIG. 3, the OS controller 200 can perform functions of the human-interface HUMAN_IF, the function controller control and monitoring COOK_CONT_MON, and the O_element monitoring O_ELE_MONITORING. The OS controller 200 can perform these functions sequentially or in parallel with each other.

The OS controller 200 (e.g., door controller) checks whether the optional soft power-off mode is instructed to be executed through the human-interface HUMAN_IF in S42. Alternatively, the OS controller 200 checks whether the optional soft power-off mode execution is instructed by the user pressing a specific button disposed on the digital controller door 100 in the second manner, e.g., the short press manner in S42.

When the optional soft power-off mode execution is instructed in the operation S42 (S42—Yes), the OS controller 200 (e.g., door controller) performs operation S45. When the optional soft power-off mode execution is not instructed in the operation S42 (S42-No), the OS controller 200 (e.g., door controller) performs operation S43.

The OS controller 200 checks whether an error has occurred in the display 160 through O_ELE_MONITORING in S43.

According to an embodiment of the present disclosure, when the display 160 is in a state in which the display 150 cannot output information (e.g., a backlight error of the LCD, an error in each pixel control, etc.) or when the display 160 is in a state in which the display 160 cannot receive a touch input, the OS controller 200 (e.g., door controller) can determine that the current situation is an operation error of the display 160 and can turn off the display 160 (e.g., it can automatically reset the display).

When the OS controller 200 (e.g., door controller) has confirmed that the error has occurred in S43, the OS controller 1300 can perform operation S45. In response to the OS controller 200 determining that no error has occurred in the display 160 in the operation S43, the process can proceed to operation S41.

Execution of the soft power-off process of S45 to S49 will be described in detail.

When the function unit 500 (e.g., main oven components) is cooking the food (that is, when the cooking appliance function provider 560 is operating), the OS controller 200 (e.g., door controller) instructs the function controller 550 (e.g., oven controller) to cancel the cooking in S45. The cooking cancelation includes terminating the operation of the cooking appliance function provider 560. This is intended to terminate operations of all components of the cooking appliance because the user is no longer able to control the cooking appliance or see information about what is going on with the microwave oven when the soft power-off mode is performed.

In addition, the OS controller 200 (e.g., door controller) instructs the function controller 550 (e.g., oven controller) to cancel the operation of the inside lamp 570 in S46. However, since the display 160 is turned off, the outside lamp 580 or the ventilation fan 590 of the function unit 500 maintains the operation thereof, which can improve safety and user convenience. That is, the OS controller 200 instructs the function controller 550 to cancel the cooking and to cancel only the operation of the inside lamp in S45 and S46.

The OS controller 200 determines whether a response to the instruction of the S45 and the S46 is received from the function controller 550 in S47.

When there is no error in the communication state between the OS controller 200 and the function controller 550, the function controller 550 cancels the cooking and cancels the operation of the inside lamp according to the instruction of S45/S46. The OS controller 200 receives a packet including a response indicating that the instruction of the S45/S46 has been performed from the function controller 550 (S47—Yes).

When the OS controller 200 has confirmed that the operation of the components constituting the function unit 500 has ended (e.g., when the main oven components have been turned off), the OS controller 200 powers off the display 160 to complete the soft power-off mode in S49.

When the response to the instruction is not received (S47—No), e.g., in response to a problem occurring in packet transmission/reception between the OS controller 200 (e.g., door controller) and the function controller 550 (e.g., main controller/oven controller), the function controller 550 cancels the cooking and the operations of the components of the function unit after an error determination time duration has elapsed due to the inability to communicate with the OS controller 200 in S48.

The OS controller 200 (e.g., door controller) cannot receive a separate response to the instruction from the function controller 550 (e.g., oven controller) due to the communication problem. However, since the function controller 550 terminates the function of the function unit 500 by itself in the communication error situation, the OS controller 200 performs operation S49 to complete the soft power-off mode.

In another embodiment of the present disclosure, in response to an error occurring in communication with the function controller 550, the OS controller 200 can immediately proceed to the operation S49. However, this process can vary depending on whether the communication error occurs in the uplink or the downlink. In this situation, the OS controller (e.g., door controller) can perform the process S45 to S49.

In summary, when an error occurs in communication with the function controller 550, according to an embodiment of the present disclosure, the OS controller 200 can perform the process S45 to S49 according to a predefined process.

Alternatively, when an error occurs in communication with the function controller 550, according to another embodiment of the present disclosure, the OS controller 200 can perform only the operation S49.

In the embodiment of FIG. 12, the OS controller 200 (e.g., door controller) can perform the optional soft power-off mode according to a user's button manipulation or in response to a command on the touch screen. Alternatively, in the embodiment of FIG. 12, when an error occurs in the display 160, the OS controller 200 can perform the error-solving soft power-off mode (e.g., automatically reset the display).

In the optional or error-solving soft power-off process, the OS controller 200 (e.g., door controller) can cancel the operation of the inside lamp 570 of the function unit 500 and maintain the operation of the outside lamp 580 of the function unit 500 and the operation of the ventilation fan 580 of the function unit 500.

When the embodiment of FIG. 10 is applied, in FIG. 12, the OS controller 200 (e.g., door controller) can perform only the operation S49 as long as the result of the operation S42 is Yes.

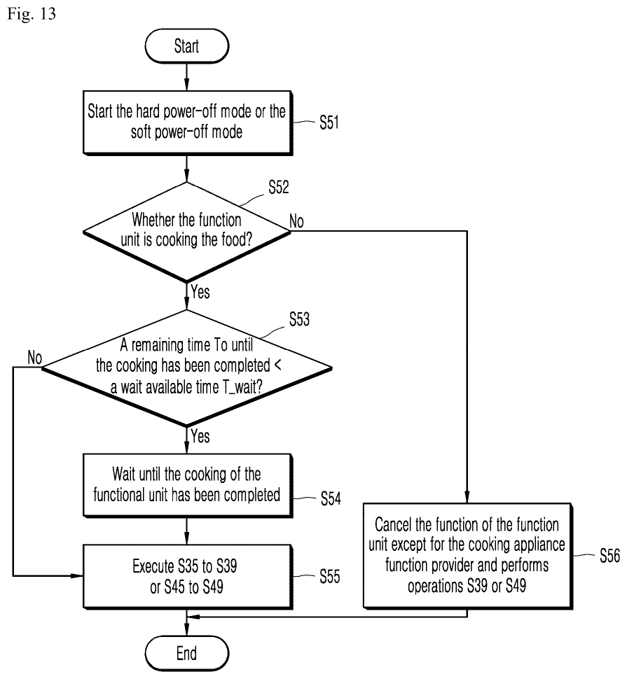

FIG. 13 is a view illustrating a process of selectively performing cooking cancelation in a power-off process according to an embodiment of the present disclosure.

Each of the hard power-off mode and the soft power-off mode can occur according to the states of the components of the digital controller door 100 (e.g., display door) or can be instructed to be executed by the user. Accordingly, an error does not occur in execution of the cooking function of the functional unit 500 or in the lamp, the ventilation fan, etc. thereof.

Accordingly, the OS controller 200 (e.g., door controller) can cancel the cooking of the function unit 500 (e.g., oven components) in the power-off process, based on a temporal factor or cook time remaining.

The OS controller 200 (e.g., door controller) starts the hard power-off mode or the soft power-off mode in S51. Then, the OS controller 200 checks whether the function unit 500 is cooking the food in S52. That is, the OS controller 200 checks whether the state of the function unit 500 is in the food cooking state, and checks whether the cooking cancelation is required in the power-off process, based on the checking result.

The cooking cancelation includes terminating the operation of the cooking appliance function provider 560 (e.g., microwave generator, heater, etc.). In response to the functional unit 500 not currently performing the cooking function, the OS controller 200 (e.g., door controller) can proceed to operation S56 because the cooking cancelation of the functional unit is not required (e.g., food is not being cooked).

When the function unit 500 does not perform the cooking function but it is necessary to cancel the operation of the inside lamp 570, the outside lamp 580, the ventilation fan 590, etc., the OS controller 200 instructs the function controller 550 to cancel the function of the function unit 500 except for the cooking appliance function provider 560 and performs operations S39 or S49 in S56.

In one example, when the cooking needs to be canceled because the functional unit is cooking the food at S52, the OS controller 200 checks whether a remaining time To until the cooking has been completed is shorter than a wait available time T_wait in S53 (e.g., checks if only a short amount of cooking time is left, such as a few seconds). In response to that the remaining time To is larger than the wait available time T_wait (that is, in response to that a time larger than the T_wait is present before the cooking has been completed), the OS controller 200 proceeds to operation S55 to perform the process S35 to S39 and S45 to S49 such as canceling the cooking of the functional unit.

On the contrary, when To is smaller than T_wait (that is, when the cooking will be finished within a time shorter than the T_wait), the OS controller 200 (e.g., door controller) proceeds to operation S54 to wait until the cooking of the functional unit has been completed and then performs the S55 in S54 (e.g., finish cooking, then shut down).

In this regard, T_wait can be preset. For example, T_wait can be set to 5 seconds, 3 seconds, etc. The OS controller 200 (e.g., door controller) can set the T_wait to vary based on the type of the power-off mode.

In an embodiment, in the situation of the imperative hard power-off mode or the situation of the optional soft power-off mode, the OS controller 200 sets T_wait to 0 so that the process should unconditionally proceed from S53 to S55. This is to allow the operation of the functional unit to be turned off without delay when the user attempts to completely turn off the digital controller door 100.

In another example, in the situation of the spontaneous hard power-off mode or the error-solving soft power-off mode, since a problem does not occur in the function unit 500 (e.g., the oven is operating fine, but only the display in the door has a problem), the OS controller 200 (e.g., door controller) sets the T_wait to 1 (sec), waits for a time within 1 second until the cooking has been completed in S54, and then proceeds to S55. That is, since the cooking will finish soon, the OS controller 200 (e.g., door controller) can wait until the cooking being performed by the function unit 500 has been completed, and then perform the operation S55, which can improve user convenience.

The maximum waiting time at S54 is T_wait. That is, even in response to the function unit 500 being in an abnormal state or a communication problem occurring, the OS controller 200 (e.g., door controller) waits for the T_wait and then proceeds to the operation S55, so that an additional operation of the function unit 500 does not occur.

In one example, when the temperature is increasing rapidly, the OS controller 200 can set T_wait to 0, and as a result, the cooking of the function unit 500 performed by the cooking appliance 1000 is immediately canceled. This is intended to prevent the heat generated due to the cooking from affecting the digital controller door 100.

The embodiment of FIG. 13 is summarized as follows. In the process of performing the power-off, the OS controller 200 (e.g., door controller) checks whether the remaining time To until the cooking performed by the cooking appliance function provider 560 of the function unit 500 has been completed is smaller than the preset wait available time T_wait. In response to To<T_wait, a signal instructing to wait until the cooking completion time and then end the operation of the components of the function unit 500 can be transmitted to the function controller 550. In this regard, the OS controller 200 (e.g., door controller) can transmit a signal instructing the termination of the operation of the components of the function unit 500 to the function controller 550. The OS controller 200 can transmit, to the function controller 550, a signal instructing to control or request the function controller 550 to terminate the operation of the components of the function unit 500.

The embodiment of FIG. 13 can be applied to the error-solving soft power-off mode. Alternatively, the embodiment of FIG. 13 can also be applied to the optional soft power-off mode as shown in FIG. 9.

In one example, in the hard power-off, when the OS controller 200 performs the spontaneous hard power-off mode based on the temperature sensed by the sensor 140 of the digital controller door 100 (e.g., smart display door), the embodiment of FIG. 13 can be applied thereto. In this situation, when the temperature change amount is large, the OS controller 200 (e.g., door controller) can immediately cancel the cooking function of the cooking appliance by setting the wait available time to 0.

Accordingly, the OS controller 200 (e.g., door controller) can set the wait available time T_wait to a value of 0 or greater based on the temperature change amount (e.g., the temperature increase amount per second, etc.).

In one example, when an error occurs in communication with the function controller 550 (e.g., oven controller) that controls the function unit 500 (e.g., oven components), the OS controller 200 (e.g., door controller) can perform the spontaneous hard power-off mode, and the embodiment of FIG. 13 can be applied thereto.

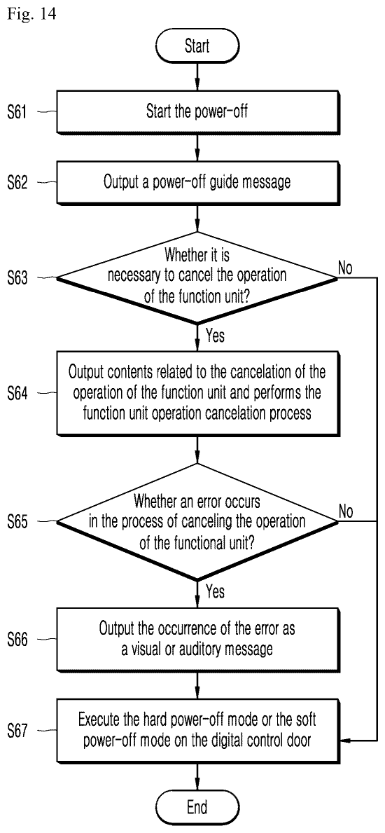

FIG. 14 is a diagram illustrating a process of outputting information related to execution of the power-off according to an embodiment of the present disclosure.

The OS controller 200 (e.g., door controller) starts the power-off when the power-off is instructed or when it is determined that the power-off is required in S61.

In addition, the OS controller 200 (e.g., door controller) controls the digital controller door 100 (e.g., display door) to output a power-off guide message in S62.

The display 160 can output a visual message (e.g., image, video, or character) to inform the user that the power-off is to be performed. In addition, the speaker/microphone 130 can output an auditory message (e.g., sound, music, or beep sound) to inform the user that the power-off is to be performed. All of the above outputs can be controlled by the OS controller 200 (e.g., door controller).

Next, the OS controller 200 (e.g., door controller) checks whether it is necessary to cancel the operation of the function unit 500 in S63. When it is determined that it is not necessary to cancel the operation of the function unit 500, the OS controller 200 performs the hard power-off mode or the soft power-off mode on the digital control door 100 in S67.

The door controller can execute the hard power-off mode to power off the door controller in response to a communication error occurring between the door controller and a main controller of the main portion.

The door controller can execute the hard power-off mode to power off the door controller in response to a temperature sensed by a sensor of the display door exceeding a predetermined condition while the main portion is not currently cooking food.

When a remaining cook time of food currently being cooked by the main portion being less than a predetermined wait available time, the door controller can wait until the remaining cook time has elapsed and then transmit a signal to the main controller to turn off at least one of the one or more functional components in the main portion.

Upon determination in the operation S63 that it is necessary to cancel the operation of the function unit 500, the digital controller door 100 outputs contents related to the cancelation of the operation of the function unit and performs the function unit operation cancelation process, under the control of the OS controller 200 in S64.

The display 160 can output a visual message to inform the user that the operation cancelation of the function unit is to be performed. The speaker/microphone 130 can output an auditory message to inform the user that the cancelation of the operation of the functional unit is to be performed. All of the above outputs can be controlled by the OS controller 200 (e.g., door controller).

As described above, when an error occurs in the process of canceling the operation of the functional unit (S65—Yes), the display 160 or the speaker/microphone 130 can output the occurrence of the error as a visual or auditory message in S66.

The OS controller 200 (e.g., door controller) performs the hard power-off mode or the soft power-off mode on the digital control door 100 in S67.

In the process of FIG. 14, in response to a function such as an auto ventilation function currently operating, a message indicating that the auto ventilation function cannot be canceled can be output through the display 160 or the speaker/microphone 130.

The auto ventilation will be described in a brief manner.

When the thermistor 595 detects the temperature, the ventilation fan 590 can automatically operate based on the detected temperature. This is referred to as the auto ventilation. The function controller 550 (e.g., oven controller) can automatically activate the auto ventilation function based on the temperature sensed by the thermistor 595 to prevent component failure or damage. That is, the function controller 550 (main controller/oven controller) can activate the auto-ventilation function when it is determined that the temperature of the thermistor is equal to or higher than a predetermined temperature, and accordingly, can notify the OS controller 200 (e.g., door controller) of information indicating that the auto-ventilation function is being activated.

In response to reception of the notification from the oven controller, the OS controller 200 (e.g., door controller) can display an auto ventilation operation state on the display 160.

The OS controller 200 (e.g., door controller) can display, on the display 160, a pop-up message indicating that the auto ventilation is being activated when the temperature sensed by the thermistor 595 reaches a predetermined temperature condition. This is a function that the user may not cancel or change arbitrarily, in order to ensure safety. Accordingly, the OS controller 200 (e.g., door controller) can display information indicating that the auto ventilation operation is being performed on the display 160 and can also output a message indicating that the auto ventilation operation cannot be changed or cancelled. The user may not set a timer for this auto ventilation operation. The ventilation fan 590 is terminated when the auto ventilation has been terminated even though the user turns off the cooking appliance 1000 on the display 160.

In addition, the auto-ventilation can be executed when a timer is set. In this situation, the OS controller 200 (e.g., door controller) can display a remaining timer time on the display 160 when the auto-ventilation operation has been terminated. In addition, when the auto-ventilation operation ends and the timer time ends, the ventilation fan 590 is also turned off.

In one example, when the user starts to operate the ventilation fan 590 during the cooking, an operation intensity of the ventilation fan 590 may not be set to a turbo level (strong intensity). After the cooking has been finished, the ventilation fan 590 can operate in the turbo level as long as the previously set ventilation fan intensity is the turbo level.

As described above, the auto ventilation function refers to a function provided to protect components of the cooking appliance 1000. Accordingly, when an error occurs in a process in which the function controller 550 cooperates with the OS controller 200, the operations of other components of the functional unit 500 can be canceled, but the operation of the ventilation fan 590 executing the auto ventilation can be maintained. Similarly, even when there is no instruction from the OS controller 200 (e.g., door controller), the function controller 550 (e.g., oven controller) can automatically start or end the operation of the ventilation fan 590 based on the temperature sensed by the thermistor 595.

Accordingly, when the user instructs the imperative hard power-off mode or the optional soft power-off mode, the OS controller 200 (e.g., door controller) can control the related components so that a message indicating that the ventilation fan 590 of the functional unit should maintain the operation thereof in the auto-ventilation situation can be output through the display 160 or the speaker/microphone 130.

In the above-described embodiment, when the OS controller 200 (e.g., door controller) is embodied as an Android board, the cooking appliance according to an embodiment of the present disclosure can control product operations such as turning off the power of the Android board or turning off the LCD screen as an embodiment of the display, according to a user's instruction, in response to the button manipulation, or based on a specific error/temperature state. Thus, stability, usability, and efficiency of the cooking appliance can be secured.

In various situations, the Android board can provide a function of stopping the microwave oven's cooking operation, turning off the screen, or cutting off the power to the microwave oven. For example, when the display (screen) 160 of the digital controller door 100 (e.g., display door) of the cooking appliance fails, a touch thereon is not performed, or the screen cannot be checked by the user.

Therefore, the Android board can automatically forcibly reset the display to perform the LCD turn-off operation. The operation of the microwave oven can be stopped or temporarily stopped until the LCD is turned on again and operates normally. When the LCD is turned on again and the touch input thereto normally works, the microwave oven can resume the previously performed operation or output a message asking whether the operation which has been stopped or temporarily stopped is to be resumed to the user.

In a first scenario, the Android board of the digital controller door can provide a user interface/user experience (UI/UX) scenario for displaying information to the user in following situations. That is, when the user turns off the power, a pop-up or a notification (beep sound) indicating the power-off can be output. In addition, when the user turns on the power again, a user interface for notifying the user that the power has been supplied to the cooking appliance can be output.

In a second scenario, the Android board of the digital controller door 100 can control each component based on a result of detecting a current state of a microwave oven, a cooktop lamp, a ventilation fan, or etc. or an external environment state.

As shown in S32 of FIG. 11, the Android board of the digital controller door 100 can perform a power-off operation of the Android board when a heating condition is satisfied, that is, when the temperature rises to a level above a specific temperature. In this situation, the Android board instructs the microcomputer as an embodiment of the function controller 550 to cancel the cooking currently in progress.

In addition, the Android board of the digital controller door 100 can request or instruct the microcomputer as an embodiment of the function controller 550 (e.g. oven controller) to turn off the oven lamp as an embodiment of the inside lamp 570, or the cooktop lamp as an embodiment of the outside lamp 580, and the ventilation fan 590.

Furthermore, the Android board can instruct the microcomputer that controls the microwave oven to stop the cooking. In this process, the Android board or the microcomputer can request or instruct an oven lamp, a cooktop lamp, or a ventilation fan to be turned off.

This is intended to prevent the possibility that the Android board malfunctions or problems occur therein due to an increase in temperature. That is, before turning off the Android board under the preset heating condition for the Android board protection (before activating the hard power-off mode), the Android board requests the microcomputer to (immediately) cancel the cooking and also requests the oven lamp, the cooktop lamp, and the ventilation to be turned off.

Accordingly, the microcomputer (function controller) that operates the microwave oven stops the cooking or operating thereof. The heating condition can be based on a variety of environmental situations and based on seasonal conditions.

As described above in S33 of FIG. 11, when the user presses a power key as an embodiment of the button for a long time (long press), the imperative power-off mode can be executed and thus, the above-described operation can be performed. Even when the Android board is turned off, the process such as the function unit operation and cooking cancelation can be performed as described above.

As described above in S34 of FIG. 11, when a communication error occurs between the microcomputer as an embodiment of the function controller 550 and the Android board as an embodiment of the OS controller 200, the microcomputer can cancel the cooking and the microcomputer can control the oven lamp, the cooktop lamp, and the ventilation fan to be turned off, as described above.

As shown in FIG. 12, in the situation of the soft power-off mode in which only the LCD is turned off, cooking of the microwave oven is canceled by the Android board (e.g., in response to pressing of a specific button, a power key, or sensing of an error).

In one example, since only the LCD is turned off, the Android board can control the microwave by itself. In response to the microwave oven currently cooking the food, the LCD can be turned off after the cooking is stopped. In response to the cooking being stopped or canceled, the LCD can be turned off. In this process, the oven lamp can be turned off while the operation of each of the cooktop lamp and the ventilation fan can be maintained. When only the LCD is turned off, the touch thereon does not work. Thus, the Android board can control the microcomputer to cancel the cooking operation and to maintain the operation of each of the cooktop lamp and the ventilation fan.

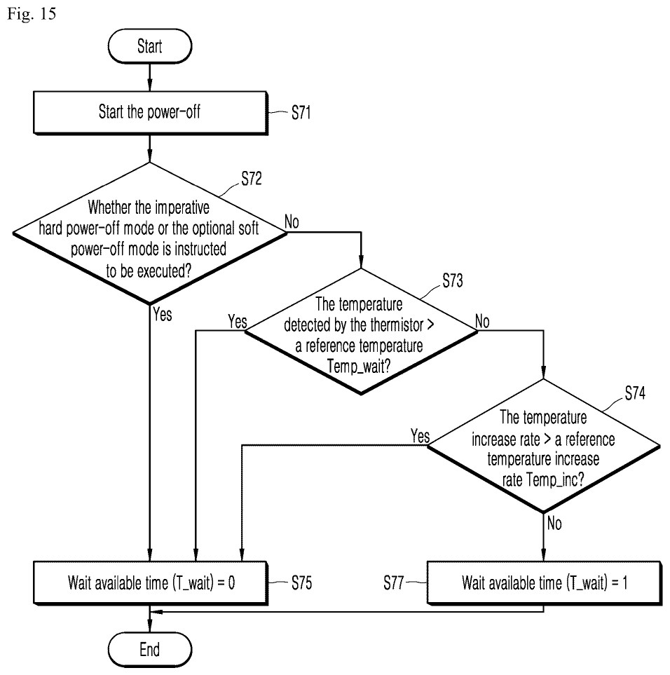

FIG. 15 is a diagram illustrating a process of increasing or decreasing a wait available time according to an embodiment of the present disclosure.

When the power-off mode is started in S71, the OS controller 200 checks whether the imperative hard power-off mode or the optional soft power-off mode has been instructed to be executed in S72. In the imperative hard power-off mode or the optional soft power-off mode, the OS controller 200 sets the wait available time T_wait to 0 in S75 so that the process should unconditionally proceed from S53 to S55 of FIG. 13. This is intended to allow the operation of the functional unit to be turned off without delay when the user attempts to completely turn off the digital controller door 100.

Upon determination that the imperative hard power-off mode or the optional soft power-off mode is not instructed to be executed in S72, the spontaneous hard power-off mode or the error-solving soft power-off mode is instructed to be executed. In this situation, since the problem does not occur in the function unit 500, the OS controller 200 (e.g., door controller) can set the wait available time T_wait to be larger than 0.

However, in order to determine another safety criterion, the OS controller 200 (e.g., door controller) checks whether the temperature detected by the thermistor 595 exceeds a reference temperature Temp_wait in S73. In this regard, the reference temperature Temp_wait is a reference temperature based on whether a high temperature is detected in the cooktop 2000, such as 50 degrees Celsius or 60 degrees Celsius (e.g., 122 F or 140 F). In response to the temperature sensed by the thermistor 595 exceeding the reference temperature Temp_wait (Yes of S73), the OS controller 200 (e.g., door controller) sets the wait available time T_wait to 0 in S75.

In S73, the OS controller 200 (e.g., door controller) can determine whether the temperature sensed by the temperature sensor disposed in the digital controller door 100 in addition to the temperature sensed by the thermistor 595 exceeds the reference temperature Temp_wait.

When the temperature sensed by the thermistor 595 is lower than or equal to the reference temperature Temp_wait, the OS controller 200 (e.g., door controller) checks whether the temperature increase rate exceeds a reference temperature increase rate Temp_inc in S74. The temperature increase rate refers to an amount of the temperature that has increased per reference time (second, minute). For example, it is assumed that the reference temperature increase rate of the thermistor 595 is 1 degree C. per second and the reference temperature increase rate of the temperature sensor disposed in the digital controller door 100 is 1.2 degrees C. per second.

When the temperature increase rate sensed by the thermistor 595 is 2 degrees C. per second, or when the temperature increase rate sensed by the temperature sensor disposed on the digital controller door is 1.5 degrees C. per second, the OS controller 200 can determine that a rapid increase in temperature is occurring.

That is, when the temperature increase rate is greater than the reference temperature increase rate Temp_inc (S74—Yes), that is, when the temperature change is large, the OS controller 200 (e.g., door controller) sets the wait available time T_wait to 0 in S75.

On the contrary, when the temperature increase rate is equal to or lower than the reference temperature increase rate Temp_inc, the OS controller 200 sets the wait available time T_wait to 1 in S76.

S73 and S74 are about an embodiment in which cooking is canceled without the waiting by setting the wait available time to 0 when the temperature is greater than a predetermined reference temperature or when the temperature changes rapidly.

Each of the temperatures and times of FIG. 15 is an example and the present disclosure is not limited to these examples.

FIG. 16 is a diagram illustrating a power-off process according to an embodiment of the present disclosure. The process of FIG. 16 refers to a process in which the OS controller 200 (e.g., door controller) transmits a power-off signal to the function unit 500 (e.g., main body/main oven components) in the power-off process and then immediately performs the power-off without receiving a separate response to the transmission of the signal.

When the power-off condition is satisfied in S81, the OS controller 200 (e.g., door controller) performs the hard power-off mode in S82 or performs the soft power-off mode in S85 based on the type of the power-off mode.

When performing the hard power-off mode in S82, the OS controller 200 (e.g., door controller) transmits a signal related to the hard power-off mode to the function unit 500 (e.g., main oven components) in S83. Then, the OS controller 200 (e.g., door controller) immediately completes the hard power-off mode in S84.

When performing the soft power-off mode in S85, the OS controller 200 (e.g., door controller) transmits a signal related to the soft power-off mode to the function unit 500 (e.g., main oven components) in S86. The OS controller 200 (e.g., door controller) immediately completes the soft power-off mode in S87.

The soft power-off mode can be implemented in various ways based on a configuration of the display 160.

When the display 160 is implemented as having a single display area according to an embodiment of the present disclosure, the soft power-off mode can be applied to the single display area.

When the display 160 is implemented as having two or more display areas according to an embodiment of the present disclosure, the soft power-off mode can be applied to one among the two or more display areas or an entire display area.

For example, the display 160 can include a first area and a second area and power can be applied to the first area and the second area in a separate manner. In this situation, one of the first area and the second area can be powered off while the other of the first area and the second area may not be powered off in the soft power-off process.

In the soft power-off process, the OS controller 200 (e.g., door controller) can soft power-off only a specific area among two or more areas of the display 160. In addition, the OS controller 200 (e.g., door controller) can control the display 160 to maintain the power to the other areas other than the specific and to output information on the other areas.

FIG. 17 is a view showing an area of a display according to an embodiment of the present disclosure.

The display 160 of FIG. 17 includes four distinct areas 161, 162, 163, and 163. Each of the areas 161, 162, 163, and 163 can independently maintain a power-on or power-off state. Each of the areas 161, 162, 163, and 163 can independently maintain a power-on or power-off state based on a type of a display panel constituting the display. According to an embodiment of the present disclosure, an OLED display panel can constitute the display 160.

Alternatively, information can be output on a partial area of an entire screen based on an arrangement of the display panels. For example, a plurality of LCD display panels can be arranged, and the OS controller 200 (e.g., door controller) can turn on or off each of the LCD display panels.

Alternatively, different types of panels can constitute the display 160 according to an implementation scheme. For example, each of the areas 161, 162, 163, and 164 can be embodied as a separate display panel (e.g., LCD or OLED display panel). These display panels can be seamlessly arranged to form a single large screen. The display panel corresponding to a partial area of the display 160 maintains a power-on state and outputs information, and the display panel corresponding to each of the other areas can be in a power-off state.

In the soft power-off process, the OS controller 200 (e.g., door controller) can power-off the second area 162, the third area 163, and the fourth area 164 while maintaining the power-on state of the first area 161. In addition, the OS controller 200 (e.g., door controller) can control the display 160 to display at least one of the cooking state information about the cooking performed in the cooking appliance or the main information provided by the cooking appliance on the first area 161 maintaining the power-on state.

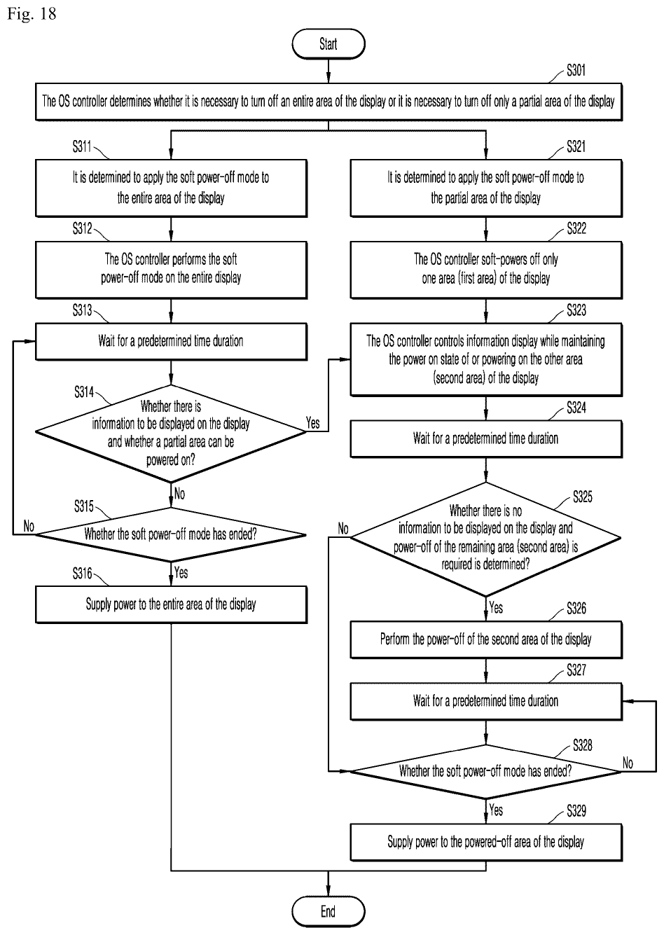

FIG. 18 is a diagram illustrating a process of turning off only a partial area of a display when an OS controller (e.g., door controller) performs the soft power-off mode according to an embodiment of the present disclosure.

When the soft power-off mode is started, the OS controller 200 (e.g., door controller) determines whether it is necessary to turn off the entire area of the display or it is necessary to turn off only a partial area of the display in S301.

For example, a situation in which the entire area needs to be turned off corresponds to a situation in which the entire power applied to the display needs to be turned off, or the situation in which the display is entirely reset or the power to the display is cut off in order to solve an operation error of the display.

Alternatively, even when the user does not need to check information through the display, it is necessary to turn off the entire area of the display.

On the other hand, a situation in which only a partial area of the display is turned off corresponds to a situation in which the power applied to the display is not required to be entirely cut off, or a situation in which the entire area of the display is not required to be reset.

Alternatively, even when the user has information to check through the display, it is necessary to turn off only a partial area of the display.

An embodiment of a situation in which only a partial area is required to be turned off corresponds to a situation in which there is important or main information to be displayed as related to the cooking appliance even when the display 160 is soft-powered off. For example, the main information can include information about a monitoring result of the cooking state, information searched for by the user. Alternatively, in a situation in which a specific state of the cooking appliance occurs and needs to be checked by the user, only a partial area is required to be turned off.

In the soft power-off state, a list of information that should be displayed can be preset by the user. Alternatively, a list of information that should be displayed can be preset by the cooking appliance.

Accordingly, the OS controller 200 (e.g., door controller) can determine whether the soft power-off mode is to be applied to an entire area or a partial area of the display, and determine a range to which the soft power-off is to be applied based on a checking result about whether there is information to be output in S301. In this regard, a range of the partial area can be set as a minimum area so that an influence of an external environment or an error to be solved thereon is minimum. Alternatively, information can be displayed in some areas of various sizes at various locations according to a configuration of the display.

When it is determined that the soft power-off mode is applied to the entire area of the display in S311, the OS controller 200 (e.g., door controller) performs the soft power-off mode on the entire display in S312.

Thereafter, after waiting for a predetermined time duration in S313, the OS controller 200 (e.g., door controller) checks whether there is information to be displayed on the display and whether a partial area can be powered on in S314. In response to that there is information to be displayed and the partial area can be powered on, the process can proceed to S323. The OS controller 200 (e.g., door controller) checks whether the soft power-off mode has ended in S315. Upon determination that the soft power-off mode has been terminated, the power is supplied to the entire area of the display in S316.

Next, the process of soft powering-off only a partial area will be described.

The OS controller 200 (e.g., door controller) determines that it will perform the soft power-off mode on a partial area in S321. In addition, the OS controller 200 (e.g., door controller) soft-powers off only one area (first area) of the display in S322, and controls information to be displayed while maintaining the power on state of or powering on the other area (second area) of the display in S323.

After waiting for a predetermined time duration in S324, whether there is no information to be displayed on the display and power-off of the remaining area (second area) is required is determined in S325. In response to there being no information to be displayed on the display and power-off of the remaining area (second area) is required (Yes-S325), the OS controller 200 (e.g., door controller) performs the power-off of the second area of the display in S326.

After waiting for a predetermined time duration in S327, the OS controller 200 (e.g., door controller) checks whether the soft power-off mode has ended in S328. When the soft power-off mode has been terminated, power is supplied to the powered-off area of the display and the process ends in S329.

Otherwise, in response to it not being necessary to power-off the area outputting information in S325, the process proceeds to S328.

In addition, in response to that the soft power-off mode is not terminated in the operation S328, the process can proceed to the operation S327.

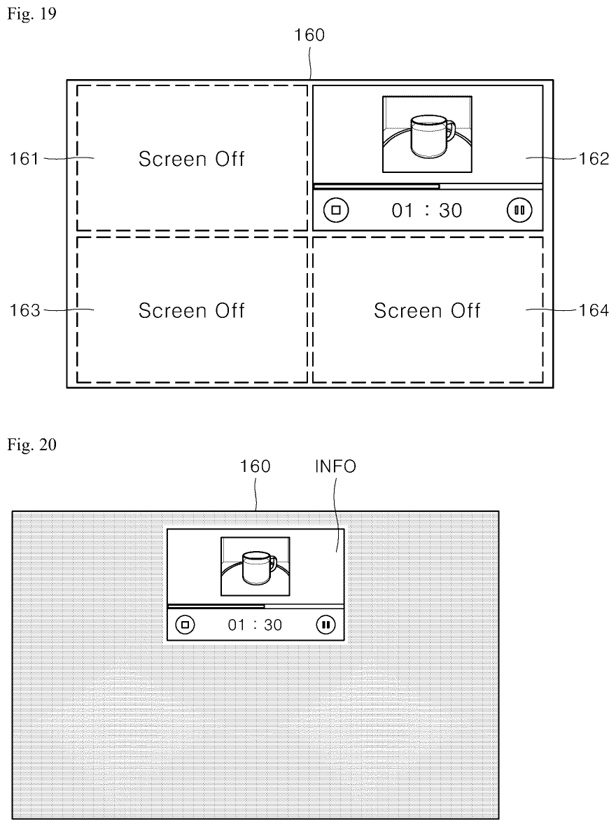

FIG. 19 is a diagram illustrating that only a partial area is soft-powered off and the other area displays information according to an embodiment of the present disclosure.

The display 160 of FIG. 19 includes first to fourth areas 161 to 164. Three areas 161, 163, and 164 thereof are in a state in which the screen is turned off in the soft power-off process. However, the second area 162 displays the current cooking state while the screen is turned on. When the cooking has been completed, the OS controller 200 (e.g., door controller) can control the display 160 to display a message indicating that the cooking has been completed on the area indicated by 162.

As illustrated in FIG. 19, the display 160 can include a plurality of areas, and the OS controller 200 (e.g., door controller) can determine whether or not to soft power-off each of the areas.

In addition, in the soft power-off mode, the OS controller 200 (e.g., door controller) can maintain the power of the specific area in the turned on state and display information on the cooking state or other informational on the specific area.

Each of the areas of FIG. 19 can be physically defined according to the configuration of the display 160. Alternatively, whether to apply the soft power-off mode to each of the areas of the display 160 can be determined by the OS controller 200. Accordingly, when the OS controller 200 (e.g., door controller) performs the soft power-off mode, the specific area to be turned off or on can have various sizes and ranges.

In an embodiment, at a first time point, the OS controller 200 (e.g., door controller) can control the display so that a width of each of the areas 161 and 163 is greater than each of a width of each of the areas 162 and 164. Thereafter, the soft power-off mode can be executed. Then, at a second time point after performing the soft power-off, the OS controller 200 can control the display so that the width of each of the areas 161 and 163 is smaller than the width of each of the areas 162 and 164.

Alternatively, the number of the areas can be increased or decreased, and the width and size of each area can be variously changed or adjusted.

FIG. 20 is a diagram illustrating an embodiment in which information is displayed in a specific area of a display in a soft power-off made according to an embodiment of the present disclosure.

In FIG. 20, information indicated as INFO is displayed on a specific area of the display 160. The OS controller 200 (e.g., door controller) can select the specific area of the display 160 that is minimally affected by the external environment in the soft power-off process and display the information INFO on the selected area (e.g., a portion that is located farther away from heat or moisture). For example, when the cooktop is installed under the display 160, a lower end of the display 160 is likely to be affected by heat. Accordingly, when the soft power-off mode is determined to be executed due to heat generated from the cooktop, the OS controller 200 can set an upper area of the display 160 as an area in which the information is to be displayed. The OS controller 200 can display the information INFO on the upper area of the display 160 and turn off all other areas of the display 160.

When the cooktop is installed on the left side of the display 160, there is a high possibility that a left area of the display 160 is affected by the heat. In this situation, the OS controller 200 (e.g., door controller) can set an area in which information is to be displayed as a right area of the display 160 and can display the information INFO on the right area thereof and can turn off all other areas of the display. In this way, the door controller can selectively and dynamically protect different areas of the display that are most vulnerable to the external environment conditions.

The OS controller 200 (e.g., door controller) can be configured to determine a position of a partial area in which information is to be displayed in the soft power-off mode based on a factor inducing a situation in which the display 160 needs to be soft-powered off. When, as described above, the factor is the heat from the cooktop, the OS controller 200 (e.g., door controller) can select an area of the display far away from the cooktop as the area in which information is to be displayed.

In addition, when the digital controller door (e.g., smart door) is in a heated state during the operation process of the cooking appliance, the OS controller 200 (e.g., door controller) can select the area of the display having the lowest temperature as the area in which information is to be displayed.

In addition, when a specific area of the display 160 is required to enter the soft power-off state due to a refresh thereof, the OS controller 200 (e.g., door controller) can select an area of the display not to be refreshed as the area in which information is to be displayed.

As described above, when it is necessary to display information on the display 160 in the soft power-off process, the OS controller 200 (e.g., door controller) can control the display 160 to select an appropriate position in the display 160 based on the factor causing the soft power-off and external environmental factors, and can turn on only the area of the display corresponding to the selected position and can display the information on the turned on area, and can turn off the other areas of the display 160.

A cooking appliance according to an embodiment of the present disclosure is provided. The cooking appliance includes a main portion including a cavity for receiving food, and one or more functional components. The main portion is configured to provide a cooking function. The cooking appliance includes a display door coupled to the main portion, and the display door includes a display configured to provide a user interface. The cooking appliance includes a door controller configured to in response to determining that at least one predetermined condition related to the display door is present or satisfied. And the door controller transmits at least one request message to a main controller of the main portion and executes a hard power-off mode to power off the door controller.

The predetermined condition includes at least one of a temperature condition of the display door being greater than a predetermined value, a user input instructing the hard power-off mode to be executed, or a communication error between the door controller and a main controller of the main portion.

The request message includes at least one of a cooking cancelation request to stop a cooking operation of the main portion, a turn off request to turn off at least one of the one or more functional components, or a request for a feedback response for informing the door controller of a status of one of the one or more functional components or a status of the cooking operation.

The door controller is configured to wait for a predetermined amount of time for receiving a response to at least one request message from a main controller of the main portion before turning off the door controller.

An embodiment of the present disclosure in which all the components are combined with each other or operate in combination with each other has been described. However, the present disclosure is not necessarily limited to this embodiment. Within the scope of the purpose of the present disclosure, at least two of all components can be selectively combined with other or can operate in the selectively combined manner with each other. Furthermore, each of the components can be implemented as an independent hardware. However, some or all of the components can be selectively combined with each other and thus can be implemented using a computer program with a program module to perform some or all of the functions combined in one or more pieces of hardware. The codes and code segments that constitute the computer program can be easily deduced by a person skilled in the art from the present disclosure. The computer program can be stored in computer readable media and read and executed by a computer, thereby implementing the method of the present disclosure. The storage media for storing the computer program can include storage media including magnetic recording media, optical recording media, and semiconductor recording devices. Additionally, the computer program implementing an embodiment of the present disclosure includes a program module transmitted in real time through an external device.

Although the embodiments of the present disclosure have been described in more detail with reference to the accompanying drawings, the present disclosure is not necessarily limited to these embodiments, and can be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A cooking appliance, comprising:
a main portion including a cavity for receiving food, and one or more functional components, the main portion being configured to provide a cooking function;
a display door coupled to the main portion, the display door including a display configured to provide a user interface; and
a door controller configured to:
in response to executing a hard power-off mode, power off the door controller, and
in response to executing a soft power-off mode, power off the display of the display door while the door controller remains in an active state.

2. The cooking appliance of claim 1, wherein the door controller is further configured to:
in response to a button mounted on the display door or displayed by the user interface being manipulated in a first manner, execute the hard power-off mode that includes powering off the door controller, and
in response to the button being manipulated in second first manner different from the first manner, execute the soft power-off mode that includes powering off the display of the display door while the door controller remains in an active state.

3. The cooking appliance of claim 1, wherein the door controller is further configured to:
execute the soft power-off mode while maintaining an operation of at least one of the one or more functional components in the main portion, or
in response to a condition being met while the display of the display door is power-off during the soft power-off mode, turn the display back on.

4. The cooking appliance of claim 1, wherein the door controller is further configured to:
transmit a signal to a main controller of the main portion to cancel a cooking operation when executing either of the hard power-off mode or the soft power-off mode.

5. The cooking appliance of claim 1, wherein the door controller is further configured to:
in response to an error occurring in the display of the display door, execute an error-solving operation in the soft power-off mode and cancel an operation of at least one of the one or more functional components of the main portion while maintaining an active operation of another one of the one or more functional components of the main portion.

6. The cooking appliance of claim 1, wherein the door controller is further configured to:
in response to at least one of a communication error occurring between the door controller and a main controller of the main portion or a temperature sensed by a sensor of the display door exceeding a predetermined condition while the main portion is not currently cooking food, execute the hard power-off mode to power off the door controller, or
in response to a remaining cook time of food currently being cooked by the main portion being less than a predetermined wait available time, wait until the remaining cook time has elapsed and then transmit a signal to the main controller to turn off at least one of the one or more functional components in the main portion.

7. The cooking appliance of claim 1, wherein the door controller is further configured to:
in response to at least one of a selection of a menu item of the user interface, a manipulation of a button disposed on the display door and a monitoring result based on a component of the display door, execute the hard power-off mode or the soft power-of mode.

8. The cooking appliance of claim 1, wherein the powering off the display of the display door according to the soft power-off mode includes turning off power to a first area of the display while maintaining power to a second area of the display.

9. The cooking appliance of claim 8, wherein the second area includes display information about at least one of a cooking state of food being cooked by the cooking appliance or status information of the cooking appliance.

10. The cooking appliance of claim 8, wherein a first distance between the first area of the display and a cooking component of the main portion or an adjacent cooking device is less than a second distance between the second area of the display and the cooking component or the adjacent cooking device.

11. A method of controlling a cooking appliance, the method comprising:
displaying a user interface by a display of a display door that is coupled to a main portion of the cooking appliance, the main portion including a cavity for receiving food and one or more functional components;
in response to executing, by a door controller of the display door, a hard power-off mode, powering off the door controller; and
in response to executing a soft power-off mode, powering off the display of the display door while the door controller remains in an active state.

12. The method of claim 11, further comprising:
in response to a button mounted on the display door or displayed by the user interface being manipulated in a first manner, executing, by the door controller, the hard power-off mode that includes powering off the door controller; and
in response to the button being manipulated in second first manner different from the first manner, executing, by the door controller, the soft power-off mode that includes powering off the display of the display door while the door controller remains in an active state.

13. The method of claim 11, further comprising:
executing, by the door controller, the soft power-off mode while maintaining an operation of at least one of the one or more functional components in the main portion, or
in response to a condition being met while the display of the display door is power-off during the soft power-off mode, turning the display back on.

14. The method of claim 11, further comprising:
transmitting, by the door controller, a signal to a main controller of the main portion to cancel a cooking operation when executing either of the hard power-off mode or the soft power-off mode.

15. The method of claim 11, further comprising:
in response to an error occurring in the display of the display door, executing by the door controller an error-solving operation in the soft power-off mode and canceling an operation of at least one of the one or more functional components of the main portion while maintaining an active operation of another one of the one or more functional components of the main portion.

16. The method of claim 11, further comprising:
in response to at least one of a communication error occurring between the door controller and a main controller of the main portion or a temperature sensed by a sensor of the display door exceeding a predetermined condition while the main portion is not currently cooking food, executing by the door controller the hard power-off mode to power off the door controller; or
in response to a remaining cook time of food currently being cooked by the main portion being less than a predetermined wait available time, waiting by the door controller until the remaining cook time has elapsed and then transmitting a signal to the main controller to turn off at least one of the one or more functional components in the main portion.

17. The method of claim 11, further comprising:
in response to at least one of a selection of a menu item of the user interface, a manipulation of a button disposed on the display door and a monitoring result based on a component of the display door, executing by the door controller the hard power-off mode or the soft power-of mode.

18. The method of claim 11, wherein the powering off the display of the display door according to the soft power-off mode includes turning off power to a first area of the display while maintaining power to a second area of the display.

19. The method of claim 18, wherein the second area includes display information about at least one of a cooking state of food being cooked by the cooking appliance or status information of the cooking appliance.

20. The method of claim 18, wherein a first distance between the first area of the display and a cooking component of the main portion or an adjacent cooking device is less than a second distance between the second area of the display and the cooking component or the adjacent cooking device.

21. A cooking appliance, comprising:
a main portion including a cavity for receiving food, and one or more functional components, the main portion being configured to provide a cooking function;
a display door coupled to the main portion, the display door including a display configured to provide a user interface; and
a door controller configured to:
in response to determining that at least one predetermined condition related to the display door is present or satisfied, transmitting at least one request message to a main controller of the main portion and execute a hard power-off mode to power off the door controller.

22. The cooking appliance of claim 21, wherein the at least one predetermined condition includes a temperature condition of the display door being greater than a predetermined value, a user input instructing the hard power-off mode to be executed, or a communication error between the door controller and a main controller of the main portion.

23. The cooking appliance of claim 21, wherein the at least one request message includes a cooking cancelation request to stop a cooking operation of the main portion, a turn off request to turn off at least one of the one or more functional components, or a request for a feedback response for informing the door controller of a status of one of the one or more functional components or a status of the cooking operation.

24. The cooking appliance of claim 21, wherein the door controller configured to:
wait for a predetermined amount of time for receiving a response to at least one request message from a main controller of the main portion before turning off the door controller.
